(19) United States
(12) Patent Application Publication
(10) Pub. No.: US 2014/0113472 A1
(43) Pub. Date: Apr. 24, 2014

(54) BUSS BAR ASSEMBLY

(71) Applicants: Bradley D. Chamberlin, Pendleton, IN (US); Clemens Burger, Noblesville, IN (US); David L. Durant, Anderson, IN (US)

(72) Inventors: Bradley D. Chamberlin, Pendleton, IN (US); Clemens Burger, Noblesville, IN (US); David L. Durant, Anderson, IN (US)

(21) Appl. No.: 13/654,563

(22) Filed: Oct. 18, 2012

(51) Int. Cl. H01R 4/60

(52) U.S. Cl. 439/212

(57) ABSTRACT

A buss bar assembly for electrically interconnecting phase leads of first, second, and third phase coil winding assemblies arranged about a stator central axis. A substantially annular dielectric body defines a buss bar central axis, and has an inner face. Substantially annular first, second, and third phase bars at least partially disposed within the body have first, second, and third pluralities, respectively, of phase bar contacts angularly spaced from each other at locations about the buss bar central axis and electrically engagable from outside of the body. The buss bar assembly is adapted for installation such that the stator central axis is substantially surrounded by the body, the coil winding assemblies and inner face interface, and phase leads of the first, second, and third phase coil winding assemblies are electrically engaged with the first, second, and third pluralities of phase bar contacts, respectively.

### CROSS-REFERENCE TO RELATED APPLICATION(S)

This application claims the benefit under Title 35, U.S.C. §119(e) of U.S. Provisional Patent Applications Ser. Nos. 61/670,236 and 61/670,473, entitled ELECTRIC MACHINE WITH BUS BAR AND METHOD OF MANUFACTURE and INTERLOCKING COIL ISOLATORS FOR RESIN RETENTION IN A SEGMENTED STATOR ASSEMBLY, respectively, both filed on Jul. 11, 2012 (Attorney Docket Nos. 22888-44, D-656 and 22888-42, D-653, respectively), the entire disclosures of which are each expressly incorporated herein by reference. This application is also related to U.S. patent application Ser. No. 13/557,890, entitled BUSS BAR ASSEMBLY HAVING ALIGNMENT AND RETENTION FEATURE, filed on Jul. 25, 2012 (Attorney Docket No. 22888-19, D-615), the entire disclosure of which is expressly incorporated herein by reference.

### BACKGROUND

The present disclosure relates to a rotating electrical device having a plurality of individual coil winding assemblies disposed about a stator central axis and provided with a plurality of electrical leads through which electrical power is transferred to or from the coil winding assemblies. Such devices may include, for example, electric motors or generators. More specifically, the present disclosure relates to a buss bar assembly through which the electrical leads are interconnected and/or power is transferred.

The interconnecting of phase and/or neutral leads extending from a plurality of individual coil winding assemblies of the stator of a rotating electrical device (e.g., a motor or generator), which are arranged about the stator central axis, is often complicated and/or time consuming. Moreover, the leads and/or their connections together or to other components can, if not properly isolated electrically, result in shorting which adversely affects device reliability.

These problems are exacerbated in multi-phase devices, wherein the multiple phase and neutral leads of different pluralities of individual coil winding assemblies must be sorted out, electrically isolated from the coil winding assembly leads of the other pluralities, and packaged within the stator housing. Meeting these requirements can adversely affect the cost and/or reliability of the device.

A buss bar assembly is often employed for interconnecting the various leads of multiple individual coil winding assemblies, and typically promotes faster, more organized, and more reliable interconnecting of the leads. Typically, however, the buss bar assembly itself must be properly oriented, packaged and installed relative to the rest of the stator, preferably within the stator housing to protect it from externally-induced damage and in a manner that facilitates automated, consistent, and proper device assembly on a mass production scale. A buss bar assembly that facilitates meeting all of these objectives would represent an improvement in the relevant art and provide attendant cost and reliability advantages vis-à-vis those now used in rotating electrical devices.

### SUMMARY

A buss bar assembly as disclosed herein provides such advantages, and hence represents a desirable advancement in the relevant art.

The present disclosure provides a buss bar assembly for electrically interconnecting phase leads of respective pluralities of first, second, and third phase coil winding assemblies arranged about a stator central axis. The buss bar assembly includes a substantially annular dielectric body defining a buss bar central axis and having, relative to the buss bar central axis, axially opposed inner and outer faces and radially inner and outer exterior surfaces. Substantially annular first, second, and third electrically conductive phase bars are disposed about the buss bar central axis and electrically isolated from each other. Each of the first, second, and third phase bars is at least partially disposed within the body and has a first, second, and third plurality, respectively, of electrical phase bar contacts angularly spaced from each other at locations about the buss bar central axis. The phase bar contacts are electrically engagable from outside of the body. The buss bar assembly is adapted for installation relative to a plurality of coil winding assemblies arranged about a stator central axis such that the stator central axis is substantially surrounded by the body, the arranged plurality of coil winding assemblies is interfaced by the body inner face, and phase leads of the first, second, and third phase coil winding assemblies are electrically engaged with the first, second, and third pluralities of phase bar contacts, respectively.

A further aspect of this disclosure is that portions of the first, second, and third phase bars located inside of the body are substantially aligned in a direction parallel with the buss bar central axis.

Another aspect of this disclosure is that portions of the first, second, and third phase bars located inside of the body substantially lie in first, second, and third substantially parallel imaginary planes, respectively, the parallel planes substantially perpendicular to the buss bar central axis, at least two of the imaginary planes optionally spaced from each other along the buss bar central axis.

A further aspect of this disclosure is that portions of the first, second, and third phase bars located inside of the body are substantially aligned in a radial direction relative to the buss bar central axis.

Another aspect of this disclosure is that portions of the first, second, and third phase bars located inside of the body and substantially aligned in a radial direction relative to the buss bar central axis are substantially concentric relative to the buss bar central axis.

A further aspect of this disclosure is that the body is over-molded relative to the first, second, and third phase bars.

A further aspect of this disclosure is that the phase bar contact locations superpose one of the radially inner and outer exterior surfaces of the body.

Another aspect of this disclosure is that the phase bar contact locations superpose the radially outer exterior surface.

Another aspect of this disclosure is that each plurality of phase bar contacts includes circumferentially extending portions of its respective substantially annular first, second, or third phase bar.

A further aspect of this disclosure is that the phase bar contact locations superpose the outer face of the body.

A further aspect of this disclosure is that portions of the phase bar contacts substantially lie in a common imaginary plane substantially perpendicular to the buss bar central axis.

A further aspect of this disclosure is that each plurality of phase bar contacts is electrically connected to its respective first, second, or third phase bar inside of the body.

Another aspect of this disclosure is that each phase bar has circumferentially alternating radially inner and radially outer phase bar segments located at radially spaced distances from the buss bar central axis, with the radially inner phase bar segments disposed within the body, and with the radially outer phase bar segments disposed outside of the body.

Another aspect of this disclosure is that the radially outer phase bar segments of each phase bar define the plurality of phase bar contacts respective to that the phase bar.

A further aspect of this disclosure is that each phase bar has a phase power transmission terminal projecting from the body for power transmission through the buss bar assembly to or from the phase leads of the respective plurality of first, second, or third phase coil winding assemblies of an arranged plurality of coil winding assemblies to which the buss bar assembly is adapted for installation.

A further aspect of this disclosure is that the buss bar assembly is for also electrically connecting neutral leads extending from the pluralities of first, second, and third phase coil winding assemblies, and further includes a substantially annular electrically conductive neutral bar disposed about the buss bar central axis. The neutral bar is at least partially disposed within the body and electrically isolated from the phase bars within the body. The neutral bar has a plurality of electrical neutral bar contacts angularly spaced from each other at locations about the buss bar central axis, the neutral bar contacts electrically engagable from outside of the body. The buss bar assembly is further adapted for installation relative to the plurality of first, second, and third phase coil winding assemblies such that neutral leads of the first, second, and third phase coil winding assemblies are electrically engaged with the plurality of neutral bar contacts.

Another aspect of this disclosure is that the neutral bar contact locations superpose the radially inner exterior surface.

The present disclosure also provides a buss bar assembly for electrically interconnecting phase leads of respective pluralities of first, second, and third phase coil winding assemblies arranged about a stator central axis. The buss bar assembly includes a substantially annular dielectric body defining a buss bar central axis and having, relative to the buss bar central axis, axially opposed inner and outer faces and radially inner and radially outer exterior surfaces. Substantially annular electrically conductive first, second, and third phase bars are disposed about the buss bar central axis and electrically isolated from each other. Each phase bar is at least partially disposed within the body and has a respective plurality of electrical phase bar contacts at fixed locations relative to the body. Each phase bar contact is electrically engageable from outside of the body and angularly spaced from another of the plurality of phase bar contacts about the buss bar central axis. The buss bar assembly is adapted for installation to an arranged plurality of first, second, and third coil winding assemblies in a mutually registered position in which the buss bar body substantially surrounds the stator central axis, the body inner face interfaces the arranged plurality of coil winding assemblies, and the first, second, and third pluralities of phase bar contacts are respectively electrically engaged with the respective phase leads of the first, second, and third coil winding assemblies.

A further aspect of this disclosure is that each of the first, second, and third pluralities of phase bar contacts are angularly spaced from another of the respective first, second, or third plurality of phase bar contacts about the buss bar central axis, and the phase bar contacts superpose a body face and/or a body exterior surface.

Another aspect of this disclosure is that the phase bar contacts of each respective first, second, and third plurality of phase bar contacts are angularly spaced from each other about the buss bar central axis.

Another aspect of this disclosure is that the phase bar contacts of the first, second, and third pluralities of phase bar contacts are angularly spaced from each other about the buss bar central axis.

Another aspect of this disclosure is that portions of the first, second, and third phase bars located inside of the body substantially lie in first, second and third imaginary planes, respectively, and the first, second, and third imaginary planes are substantially perpendicular to the buss bar central axis.

Another aspect of this disclosure is that at least two of the first, second, and third imaginary planes are spaced along the buss bar central axis.

Another aspect of this disclosure is that the phase bar contacts of each respective first, second, or third plurality of phase bar contacts are located at a substantially common distance from a fixed point on the body in a direction substantially parallel with the buss bar central axis.

Another aspect of this disclosure is that the phase bar contacts of the first, second, and third pluralities of phase bar contacts are located at a substantially common distance from a fixed point on the body in a direction substantially parallel with the buss bar central axis.

Another aspect of this disclosure is that circumferentially extending segments of the first, second, and third phase bars respectively define the first, second, and third pluralities of phase bar contacts.

Another aspect of this disclosure is that portions of the circumferentially extending segments of the first, second, and third phase bars which define the first, second, and third pluralities of phase bar contacts substantially lie in a common imaginary plane substantially perpendicular to the buss bar central axis.

Another aspect of this disclosure is that relative to each of the first, second, and third phase bars, portions of the phase bar, located at opposite ends of each circumferentially extending segment that defines a phase bar contact, extend out of the common imaginary plane.

Another aspect of this disclosure is that relative to each of the first, second, and third phase bars, at least one of the portions of the phase bar, located at opposite ends of each circumferentially extending segment that defines a phase bar contact, extends out of the common imaginary plane at a location outside of the buss bar body.

A further aspect of this disclosure is that the body includes a molded first portion defining a recess in which are disposed the first, second, and third phase bars, and the buss bar assembly further includes a second portion superposing the phase bars and connected to the first portion.

Another aspect of this disclosure is that the second portion includes a liquid resin that has been received into the first portion recess and cured.

### BRIEF DESCRIPTION OF THE DRAWINGS

The above-mentioned aspects of exemplary embodiments will become more apparent and will be better understood by reference to the following description of those embodiments taken in conjunction with the accompanying drawings, wherein:

FIG. 1 is a partial, axially outer perspective view of an arranged plurality of individual coil winding assemblies disposed about a stator central axis;

FIG. 2 is an enlarged, axially outer perspective view of one of the plurality of individual coil winding assemblies shown in FIG. 1;

FIG. 3A is a partial, cross-sectioned, perspective view of one version of the arranged plurality of individual coil winding assemblies shown in FIG. 1 fixedly disposed within a stator housing, and a rotor adapted for rotation about the stator central axis;

FIG. 3B is a partial, cross-sectioned, perspective view of another version of the arranged plurality of individual coil winding assemblies shown in FIG. 1 fixedly disposed within a stator housing, and a rotor adapted for rotation about the stator central axis;

FIG. 4A is an axially outer perspective view of a first embodiment bus bar assembly, showing in dashed lines the portions of its component first, second, and third phase bars that are located within its overmolded body, and which is adapted for use with the arranged plurality of coil winding assemblies shown in FIG. 3A;

FIG. 4B is an axially outer perspective view of a second embodiment buss bar assembly similar to the first embodiment buss bar assembly shown in FIG. 4A, but which also includes a neutral bar partially disposed within the overmolded buss bar body and is adapted for use with the arranged plurality of coil winding assemblies shown in FIG. 3B;

FIG. 5A is an enlarged, partial, cross sectioned, perspective view of the first embodiment buss bar assembly shown in FIG. 4A;

FIG. 5B is an enlarged, partial, cross sectioned, perspective view of the second embodiment buss bar assembly shown in FIG. 4B;

FIG. 5C is a fragmented, radially outer exterior view of the first or second embodiment buss bar assembly showing an alternative orientation of its phase power terminals;

FIG. 6A is a side view of the first embodiment buss bar assembly shown in FIG. 4A;

FIG. 6B is a side view of the second embodiment buss bar assembly shown in FIG. 4B;

FIG. 7A is an axially outer plan view of the first embodiment buss bar assembly shown in FIG. 4A;

FIG. 7B is an axially outer plan view of the second embodiment buss bar assembly shown in FIG. 4B;

FIG. 8A is an exploded, axially outer perspective view of the first, second, and third phase bars of the first embodiment phase bar assembly shown in FIG. 4A and the second embodiment phase bar assembly shown in FIG. 4B;

FIG. 8B is an axially outer perspective view of the neutral bar of the second embodiment buss bar assembly shown in FIG. 4B;

FIG. 9A is a partial, cross-sectioned perspective view of the coil winding assembly arrangement and stator housing shown in FIG. 3A and the first embodiment buss bar assembly shown in FIG. 4A mutually registered together;

FIG. 9B is a partial, cross-sectioned perspective view of the coil winding assembly arrangement and stator housing shown in FIG. 3B and the second embodiment buss bar assembly shown in FIG. 4B mutually registered together;

FIG. 10 is an axially outer perspective view of the assemblage shown in FIG. 9B, with the outline of the stator housing shown in dashed lines;

FIG. 11 is an axially outer perspective view of a third embodiment phase bar assembly that includes first, second, and third phase bars, a neutral bar, and an overmolded body;

FIG. 12 is an enlarged, partial, cross-sectioned perspective view of the third embodiment buss bar assembly shown in FIG. 11;

FIG. 13 is an axially outer perspective view of the third embodiment buss bar assembly shown in FIG. 11, with the outline of its overmolded body shown in dashed lines;

FIG. 14 is an axially outer perspective view of a fourth embodiment buss bar assembly that includes first, second, and third phase bars, a neutral bar, and an overmolded body;

FIG. 15 is an enlarged, partial, cross-sectioned perspective view of the fourth embodiment buss bar assembly shown in FIG. 14;

FIG. 16 is a side view of the fourth embodiment buss bar assembly shown in FIG. 14;

FIG. 17 is an axially outer plan view of the fourth embodiment buss bar assembly shown in FIG. 14;

FIG. 18 is an axially outer perspective view of a fifth embodiment buss bar assembly that includes first, second, and third phase bars, a neutral bar, and an overmolded body;

FIG. 19 is an enlarged, partial, cross-sectioned perspective view of the fifth embodiment buss bar assembly shown in FIG. 18;

FIG. 20 is an axially outer plan view of the fifth embodiment buss bar assembly shown in FIG. 18;

FIG. 21 is an axially inner perspective view of the fifth embodiment buss bar assembly shown in FIG. 18;

FIG. 22 is an axially outer perspective view of a sixth embodiment buss bar assembly that includes first, second, and third phase bars and a neutral bar, and a molded, substantially annular body having a U-shaped channel in which the phase and neutral bars are disposed;

FIG. 23 is an axially inner perspective view of the sixth embodiment buss bar assembly shown in FIG. 22;

FIG. 24 is an axially outer perspective view of a seventh embodiment buss bar assembly that includes first, second, and third phase bars and an overmolded body;

FIG. 25 is an enlarged, partial, cross-sectioned perspective view of the seventh embodiment buss bar assembly shown in FIG. 24;

FIG. 26 is an axially outer plan view of the seventh embodiment buss bar assembly shown in FIG. 24;

FIG. 27 is an axially inner perspective view of the seventh embodiment buss bar assembly shown in FIG. 24;

FIG. 28 is an axially outer, partial perspective view of an eighth embodiment buss bar assembly that includes first, second, and third phase bars, a neutral bar, and a molded substantially annular body having substantially concentric channels in which the phase and neutral bars are disposed and potted;

FIG. 29 is an enlarged, partial, cross-sectioned perspective view of the eighth embodiment buss bar assembly shown in FIG. 28;

FIG. 30 is an axially outer plan view of the eighth embodiment buss bar assembly shown in FIG. 28;

FIG. 31 is an axially inner, partial perspective view of the eighth embodiment buss bar assembly shown in FIG. 28;

FIG. 32 is an axially outer perspective view of a ninth embodiment buss bar assembly that includes interwoven first, second, and third phase bars, and an overmolded body;

FIG. 33 is an enlarged, partial, cross-sectioned perspective view of the ninth embodiment buss bar assembly shown in FIG. 32;

FIG. 34 is a side view of the ninth embodiment buss bar assembly shown in FIG. 32; and

FIG. 35 is an axially outer plan view of the ninth embodiment buss bar assembly shown in FIG. 32.

Corresponding reference characters indicated corresponding parts throughout the several views. Although the drawings represent embodiments, the drawings are not necessarily to scale or to the same scale and certain features may be exaggerated in order to better illustrate and explain the present invention.

### DETAILED DESCRIPTION OF EXEMPLARY EMBODIMENTS

The embodiments described below are not intended to be exhaustive or to limit the invention to the precise forms disclosed in the following detailed description. Rather, the embodiments are chosen and described so that others skilled in the art may appreciate and understand the principles and practices of the present invention.

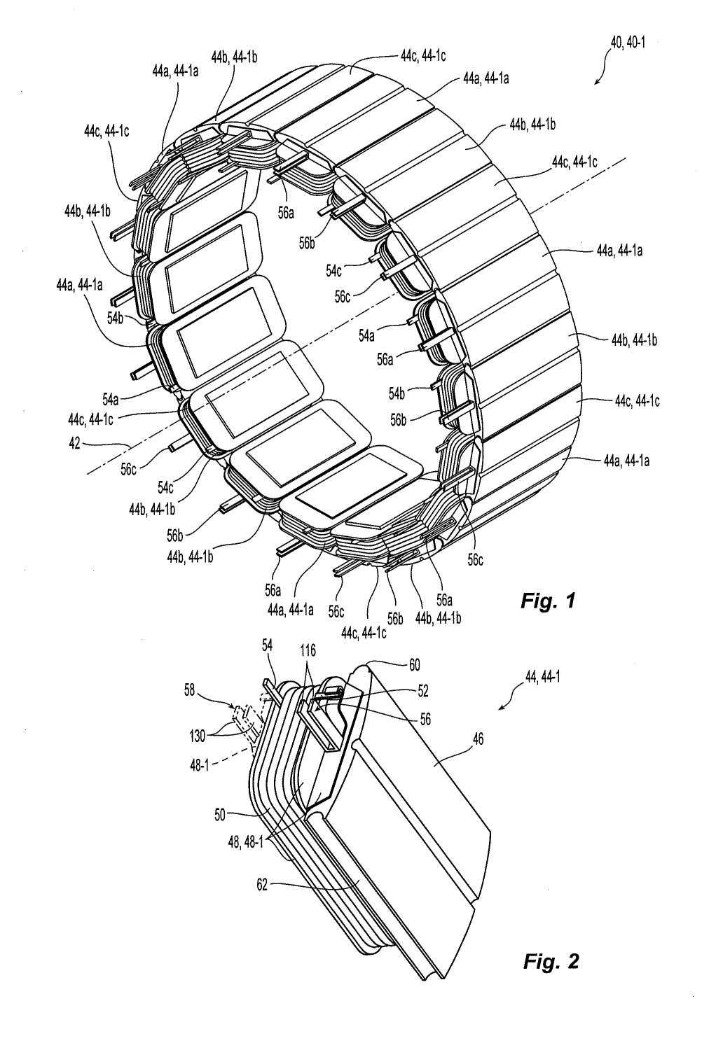

FIG. 1 shows a plurality 40 or 40-1 of individual coil winding assemblies arranged about a stator central axis 42, and forms part of a stator for a rotating electric device. The depicted stator includes eighteen identical individual coil winding assemblies 44 or 44-1, arranged in pluralities of first, second, and third phase coil winding assemblies 44a, 44b, and 44c, or 44-1a, 44-1b, and 44-1c, respectively, each plurality evenly distributed about the stator central axis 42. The characterization as a first, second, or third phase coil winding assembly is relative to the other coil winding assemblies in the stator, and may or may not be established prior to final assembly of the rotating electric device of which the stator is a part. Herein, the reference numeral suffix a, b, or c relates to whether the identified element is associated with the first, second, or third electrical phase, respectively, in the context of the exemplary embodiment being described.

The arranged plurality 40-1 is a variation of plurality 40 that differs primarily in that it has neutral leads adapted for being interconnected through the buss bar assembly, as described hereinbelow. Referring to FIG. 2, one of the individual coil winding assemblies 44 of plurality 40 is shown, and may be a first, second, or third phase coil winding assembly 44a, 44b, or 44c. FIG. 2 also depicts a coil winding assembly 44-1, described further hereinbelow, used in plurality 40-1. Each coil winding assembly 44-1 may also be a first, second, or third phase coil winding assembly 44-1a, 44-1b, or 44-1c.

The coil winding assemblies 44, 44-1 each include a segmented stack 46 of ferrous laminae that, combined together in the arranged plurality 40, 40-1 of coil winding assemblies, at least partially form the stator iron. Each laminae stack 46 has an over-molded insulator 48 or 48-1 of a suitable thermoplastic material, and a wire coil 50 that is wound about the insulator 48, 48-1. The wire coil 50 has a first, phase lead end 52 and an opposite second, neutral lead end 54.

A phase lead terminal 56 is provided at each first, phase lead end 52. As shown in FIG. 1, phase lead terminals 56a, 56b, and 56c, and neutral leads 54a, 54b, and 54c, extend from each of the first, second, and third phase coil winding assemblies 44a, 44b, and 44c, or 44-1a, 44-1b, and 44-1c, respectively. Relative to the coil winding assembly arrangement 40, 40-1, circumferentially adjacent phase lead terminals 56 are spaced 20° from each other about the stator central axis 42. The neutral lead ends 54 are shown truncated in FIG. 1 and, relative to each coil winding assembly 44-1, each neutral lead end 54 is connected to a neutral lead terminal 58 rigidly affixed to its insulator 48-1.

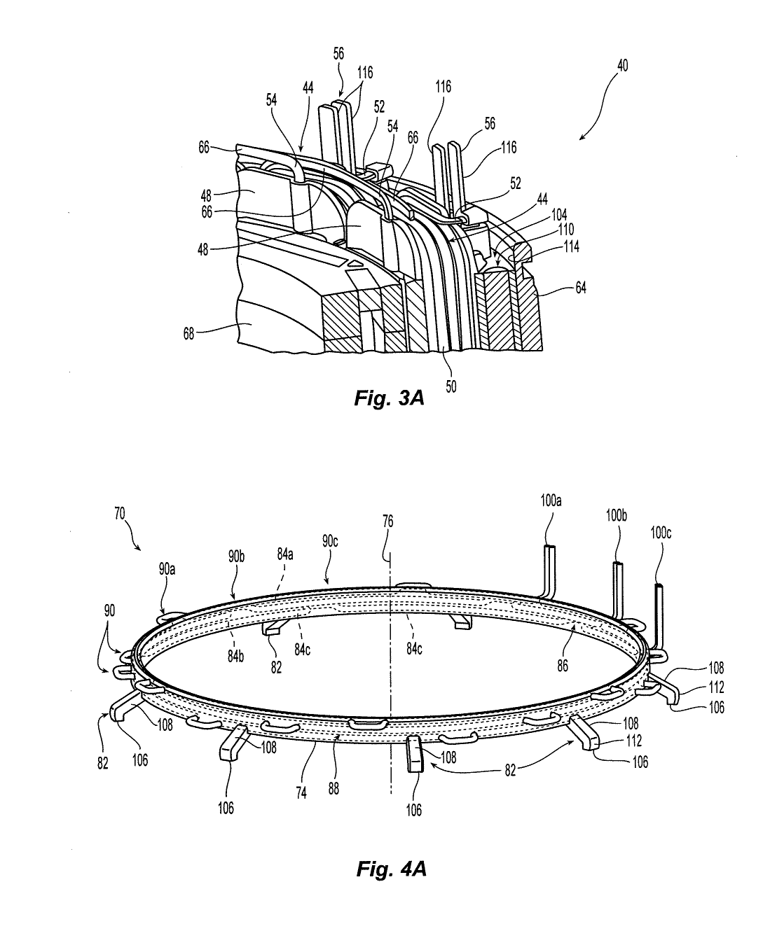

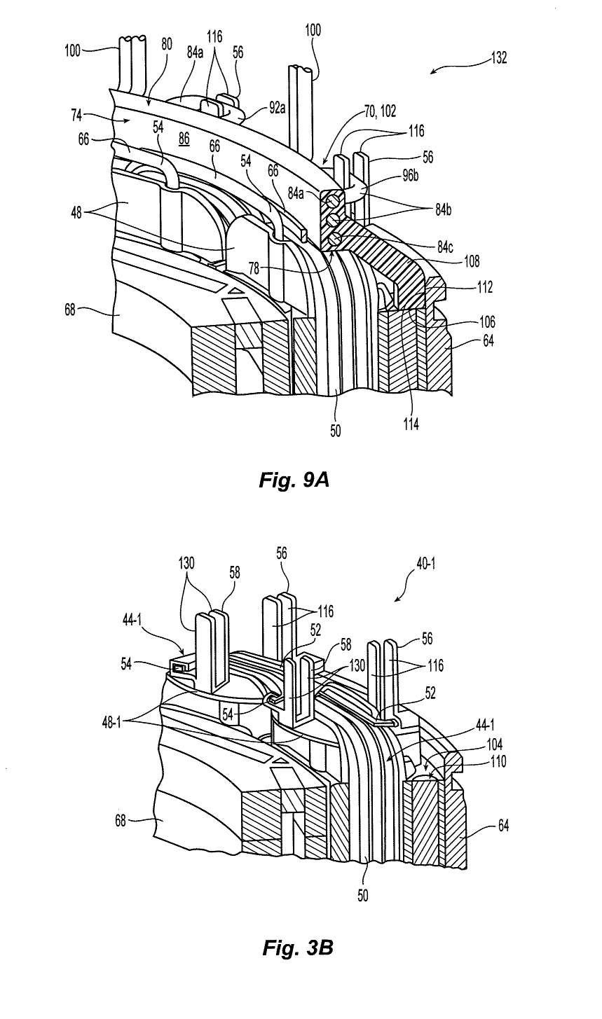

Each segmented laminae stack 46 includes a tongue 60 on one elongate lateral edge, and a groove 62 on the opposite elongate lateral edge; the tongue 60 and groove 62 of adjacent coil winding assemblies 44, 44-1 are interfitted to define the cylindrical arrangement 40, 40-1 of coil winding assemblies 44, 44-1. The arranged plurality 40, 40-1 of coil winding assemblies 44, 44-1 is disposed within a cylindrical stator housing 64, shown in FIGS. 3A and 3B, which respectively show the arranged pluralities 40 and 40-1 of individual coil winding assemblies 44 or 44-1, with which the first and second buss bar assembly embodiments, respectively, described hereinbelow, are adapted for use. Relative to the plurality 40, the neutral lead ends 54 of the coil winding assemblies 44 continuously extend into neutral lead portions 66 that are arcuately wrapped about the stator central axis 42 within the stator housing 64, as shown in FIG. 3A. The extended neutral lead portions 66 are electrically connected to each other externally of the buss bar assembly, and to a common neutral terminal of the device (not shown). As shown in FIG. 3A, the extended neutral lead portions 66 extend continuously from the respective second, neutral lead ends 54 of the coil winding assemblies 44. FIG. 3A also shows a rotor 68 encircled by the arranged plurality 40 coil winding assemblies 44 and adapted for rotation about the stator central axis 42.

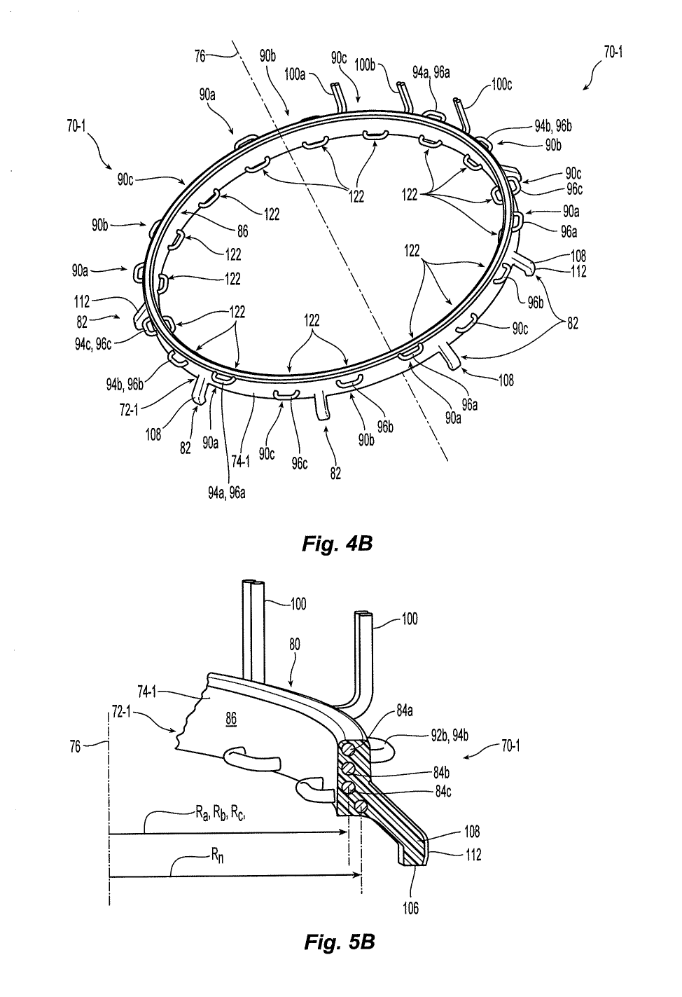

FIGS. 4A, 5A, 6A, and 7A show a first embodiment buss bar assembly 70 that includes a dielectric, injection molded thermoplastic body 72 defining a substantially annular housing 74. In describing the various buss bar assembly embodiments and their components herein disclosed, the term “substantially annular” is to be construed as encompassing a structure which defines a continuous or segmented circular or noncircular annulus that surroundingly extends at least 180° about a central axis defined thereby. Moreover, as used herein, the term “substantially surround” is to be construed as a relationship in which one element extends at least 180° about another element. A C-shaped structure, for example, may be characterized as being substantially annular and/or substantially surrounding.

Housing 74 defines a buss bar central axis 76. Buss bar body 72 or housing 74 has an inner face 78 and an axially opposed outer face 80. In describing the various buss bar assembly embodiments herein disclosed, the axially opposed inner and outer body faces are surfaces and surface portions which are visible when viewed in the respective, opposite directions along the body central axis, including those surfaces and surface portions that are substantially perpendicular or oblique relative to that axis.

Extending from the substantially annular housing 74 is an integrally formed support 82 of the buss bar body 72. Substantially annular first, second, and third phase bars 84a, 84b, and 84c are individually electrically connectable to phase lead terminals 56a, 56b, or 56c of the respective first, second, or third phase coil winding assemblies 44a, 44b, 44c. Thus, the wire coil first, phase lead ends 52 of each plurality of first, second, and third phase coil winding assemblies 44a, 44b, or 44c are electrically interconnected through the respective phase bar 84a, 84b, or 84c. The first, second, and third round wire phase bars 84a, 84b, and 84c are substantially concentric about the buss bar central axis 76, axially stacked in a direction parallel with the buss bar central axis 76, and partially disposed within the substantially annular housing 74. The phase bars 84 are out of electrical communication with each other, and are themselves mold inserts about which the plastic buss bar body 72 is overmolded, which, as will be the case in embodiments disclosed elsewhere herein, may be done by known injection molding techniques not discussed herein.

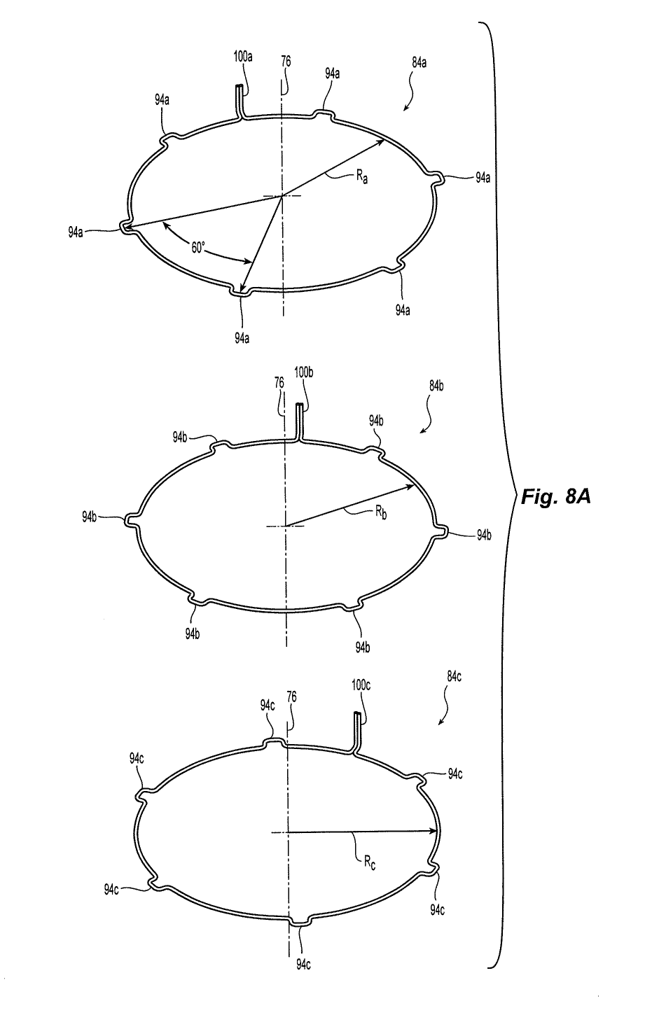

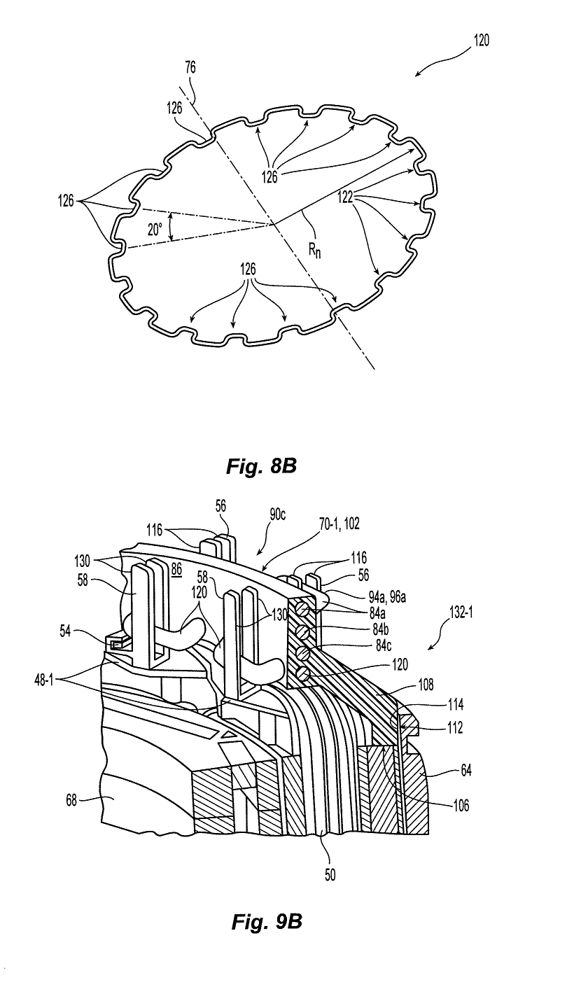

The identical first, second, and third phase bars 84a, 84b, and 84c shown in FIG. 8A, are each centered about the buss bar central axis 76 but are angularly offset relative to each other in the buss bar body 72 by 20° or 40°. Referring to FIGS. 4A and 7A, the buss bar assembly substantially annular housing 74 has a radially inner exterior surface 86 and a radially outer exterior surface 88. In describing the various buss bar assembly embodiments herein disclosed, the radially inner and radially outer exterior body surfaces are surfaces and surface portions which are visible when viewed in the respective radial directions way and towards the body central axis, including those surfaces and surface portions that are substantially parallel with or oblique relative to that axis.

At angularly distributed locations 90 on the buss bar body 72, phase bar electrical contacts 92 are provided at which the phase bars 84 are electrically engageable from outside of the buss bar body. In buss bar assembly 70, locations 90a, 90b, and 90c are where the first, second, and third phase bar electrical contacts 92a, 92b, and 92c, respectively, superpose the radially outer surface 88 of the buss bar body 72. Each of the phase bars 84a, 84b, and 84c is associated with a plurality of contacts 92a, 92b, and 92c, respectively. In the first embodiment buss bar assembly 70, the contacts 92 of each phase bar 84 are defined by circumferentially extending phase bar portions 94. With reference to FIGS. 4A and 8A, the circumferentially extending portions 94a, 94b, or 94c of the first, second, or third phase bars 84a, 84b, 84c define contacts 92a, 92b, or 92c. Each of the contacts 92 is electrically engageable from outside of the buss bar body 72, and when the buss bar assembly 70 is installed on the stator, is connected to one of the individual coil winding assemblies 44 via its phase lead terminal 56. Relative to each phase bar 84, each of its contacts 92 is spaced 60° from an adjacent contact 92, as shown in FIG. 8A. Thus, equiangularly distributing all of contacts 92 about the buss bar central axis 76 results in a 20° separation between circumferentially adjacent contacts. It can thus be understood that in certain embodiments of a buss bar assembly disclosed herein as adapted for installation on a stator having an arranged plurality of eighteen individual coil winding assemblies as described above, its substantially annular buss bar body may extend only 340° about the buss bar assembly central axis and each individual substantially annular phase bar may only extend 300° about that axis. Altering the number of individual coil winding assemblies in a stator can therefore accommodate other angles by which a substantially annular buss bar assembly body and/or each phase bar may extend about the central axis. As shown in FIG. 8A, however, substantially annular phase bars 84a, 84b, and 84c are identical and have a common first radius R₁ at which the phase bar 84 primarily lies, and a relatively larger common second radius R₂ at which their portions 94 lie.

At each location 90 is a phase bar electrical connection terminal 96 through which electrical communication with a respective phase bar contact 92 is established. First, second, and third phase bar electrical connection terminals 96a, 96b, 96c are located at contact locations 90a, 90b, and 90c, respectively. In the depicted first embodiment buss bar assembly 70, the phase bar electrical connection terminals 96 are defined by the phase bar circumferentially extending portions 94 themselves. Those of ordinary skill in the art will appreciate, however, that the buss bar assembly 70 may instead incorporate separate connection terminals (not shown) attached to the contacts 92, and that the phase bars 84 themselves may be entirely disposed within the buss bar housing 74.

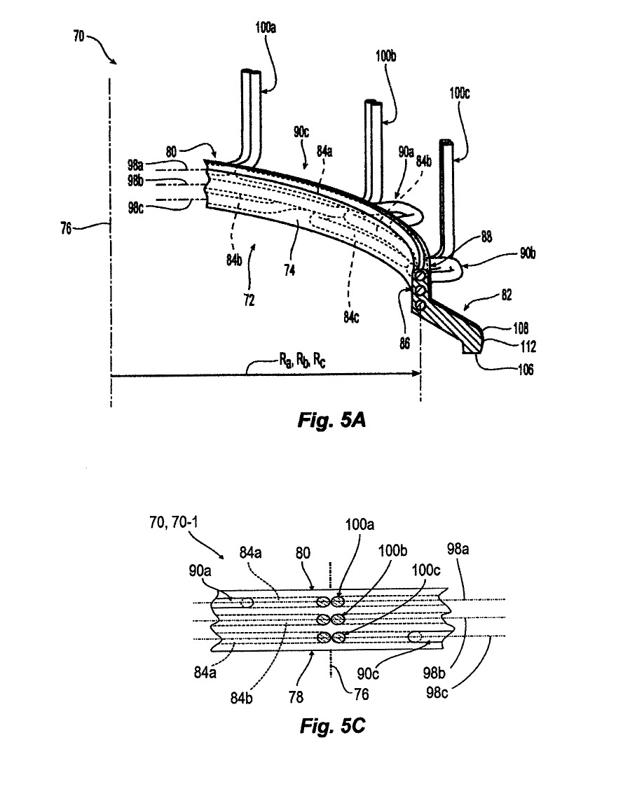

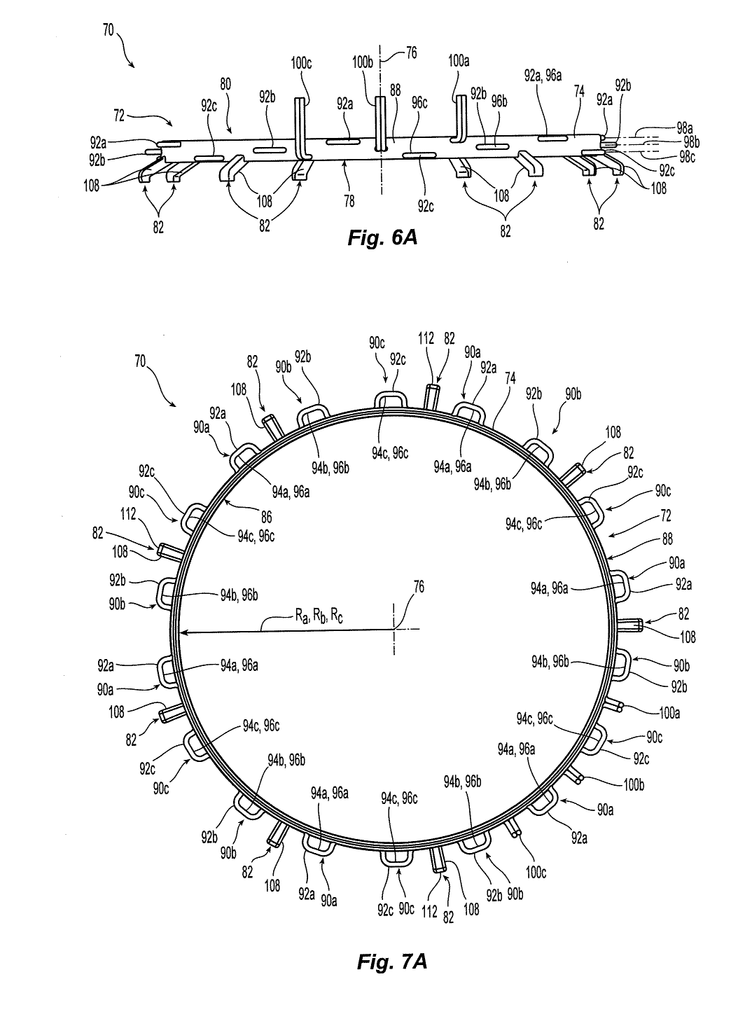

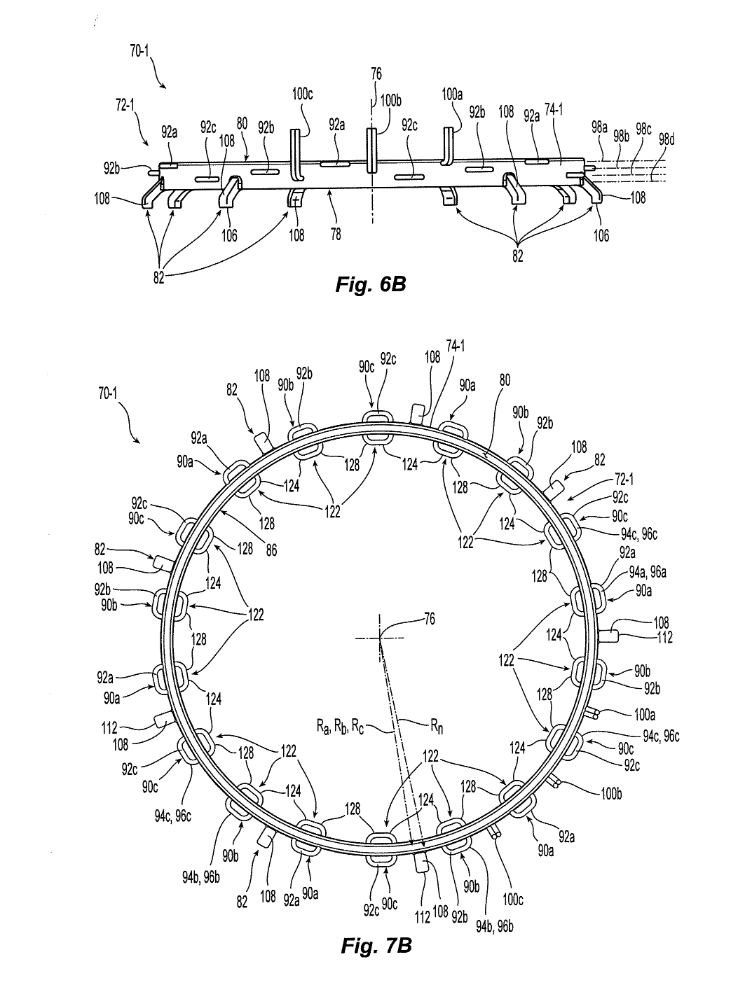

As shown in FIGS. 5A and 6A, the phase bars 84a, 84b, and 84c and their respective contacts 92a, 92b, and 92c substantially lie in a respective one of spaced, parallel imaginary planes 98a, 98b, and 98c that are perpendicular to and spaced along the buss bar central axis 76. The phase bars 84 are thus stacked axially relative to buss bar central axis 76. Each phase bar 84 includes a phase power terminal 100 by which electrical power to or from the coil winding assemblies 44 is transferred to or from the buss bar assembly 70, as the case may be. First, second, and third phase power terminals 100a, 100b, and 100c of buss bar assembly 70 are defined by the opposite ends of the round wire material between which the substantially annular first, second, and third phase bars 84a, 84b, and 84c, respectively, are formed, and extend outwardly away from the substantially annular housing 74 in a radially and axially outward direction. Relative to each substantially annular phase bar 84, its phase power terminals 100 is circumferentially centered between a pair of adjacent contacts 92. Thus, the phase power terminals 100 of the three phase bars 84 may, for example, be spaced from each other as shown by either 20° or 40° about the buss bar central axis 76. Alternatively, the locations at which the phase power terminals 100a, 100b, and 100c extend from the buss bar body may be radially aligned relative to central axis 76 and spaced axially therealong, preferably circumferentially centered between locations 90 of a pair of adjacent contacts.

Referring to FIG. 9A, the first embodiment buss bar assembly 70 has a registered position 102 relative to the arranged plurality 40 of individual coil winding assemblies 44. In the registered position 102, the buss bar assembly 70 and the arranged plurality 40 of coil winding assemblies 44 are operably interengaged or mutually registered with each other such that the buss bar body support 82 engages the axially outer face defined by the cylindrical coil winding assembly arrangement 40 at discrete, circumferentially spaced locations 104 about the stator central axis 42. Abutting the coil winding assembly arrangement 40 at locations 104 are the terminal ends 106 of buss bar legs 108. Legs 108 define the buss bar body support 82, and extend radially from the substantially annular housing 74. The locations 104 at which the leg terminal ends 106 abut the arranged plurality 40 of coil winding assemblies 44 in the registered position 102 are on axially outer surfaces 110 of the segmented laminae stacks 46. The abutting engagement between leg terminal ends 106 and surfaces 110 establishes the axial position of the installed buss bar assembly 70 relative to the coil winding assembly arrangement 40, and this position is fixed upon retaining the buss bar assembly to the stator.

As best seen in FIG. 9A, the legs 108 have radially outermost surfaces 112 near their terminal ends 106. Radial surfaces 112 abuttingly engage the interfacing radially inner surface 114 of the stator housing 64. The abutting engagement between radial surfaces 112 and 114 establishes a radial position of the buss bar assembly 70 when it and the coil winding assembly arrangement 40 are mutually registered with each other, and this position is fixed upon retaining the buss bar assembly to the stator, which may be done, for example, by a method disclosed in related U.S. patent application Ser. No. 13/557,890, the disclosure of which is incorporated herein by reference above. In the buss bar assembly's fixed axial and radial positions relative to the coil winding assembly arrangement 40, contacts 92 are electrically isolated from the coil winding assemblies 44 except through phase lead terminals 56. Each phase lead terminal 56 is provided with a pair of spaced blades or prongs 116 that, during registration, as the arranged plurality 40 and the buss bar assembly 70 relatively move towards each other with their respective axes 42 and 76 substantially coincident, slidably engage a circumferentially extending portion 94, or terminal 96, of a respective phase bar 84.

Referring to FIGS. 4B, 5B, 6B, and 7B, the second embodiment buss bar assembly 70-1 is similar to the first embodiment buss bar assembly 70 except that it additionally includes a substantially annular neutral bar 120, which is shown in FIG. 8B. In buss bar assembly 70-1, electrical communication with the neutral bar 120 can be had from outside of the buss bar body 72-1 via neutral bar electrical contacts 124 at locations 122 about the buss bar central axis 76. The locations 122 are where the neutral bar electrical contacts 124 superpose the radially inner surface 86 of buss bar assembly substantially annular housing 74-1. The neutral bar 120 and its contacts 124 substantially lie in a fourth imaginary plane 98d perpendicular to the buss bar axis 76 and spaced from the third plane 98c, in which the third phase bar 84c and its contacts 92c substantially lie. The neutral contacts 124 are defined by circumferentially extending portions 126 of the neutral bar 120. The neutral bar 120 primarily lies at a distance of first radius R₁ from the buss bar central axis 76, i.e., a distance common with the phase bars 84, and its portions 126 are located at a relatively smaller, third radius R₃. As depicted, in buss bar assembly 70-1 these circumferentially extending portions 126 define eighteen equiangularly distributed neutral bar electrical connection terminals 128 in a manner similar to that by which the phase bar electrical connection terminals 96 are defined by the circumferentially extending portions 94 of the phase bars 84.

Referring again to FIG. 2, each individual coil winding assembly 44-1 has a neutral lead terminal 58 that is rigidly affixed to its overmolded insulator 48-1, which differs from insulator 48 of coil winding assembly 44 in that it provides a placement location for and support to the neutral lead terminal 58. These neutral lead terminals 58 include a pair of spaced blades or prongs 130 that, during registration, as the arranged plurality 40-1 and the buss bar assembly 70-1 relatively move towards each other with their respective axes 42 and 76 substantially coincident, slidably engage a circumferentially extending portion 126, or terminal 128, of the neutral bar 120.

Each of the angularly distributed neutral bar contacts 124 is spaced 20° from an adjacent neutral bar contact 124. Thus, in an unshown variation, the substantially annular neutral bar 120 may extend only 340° about the central axis. As mentioned above in connection with the bodies and phase bars of buss bar assembly embodiments adapted for installation on a stator having an arranged plurality of eighteen individual coil winding assemblies, altering the number of individual coil winding assemblies in a stator can therefore accommodate other angles by which a substantially annular neutral bar may extend about the central axis.

Referring to FIG. 7B, it can be seen that the circumferential locations 90 and 122 of a pair of associated phase bar and neutral bar contacts 92, 124 for connection to any one coil winding assembly 44-1 may be radially aligned relative to each other, thereby accommodating the shown positioning of the coil winding assembly terminals 56 and 58. The radial alignment between each pair of associated contact locations 90 and 122 may be angularly offset, and the radial spacing between the contact location pair 90, 122 may be altered, however, as stator design considerations warrant.

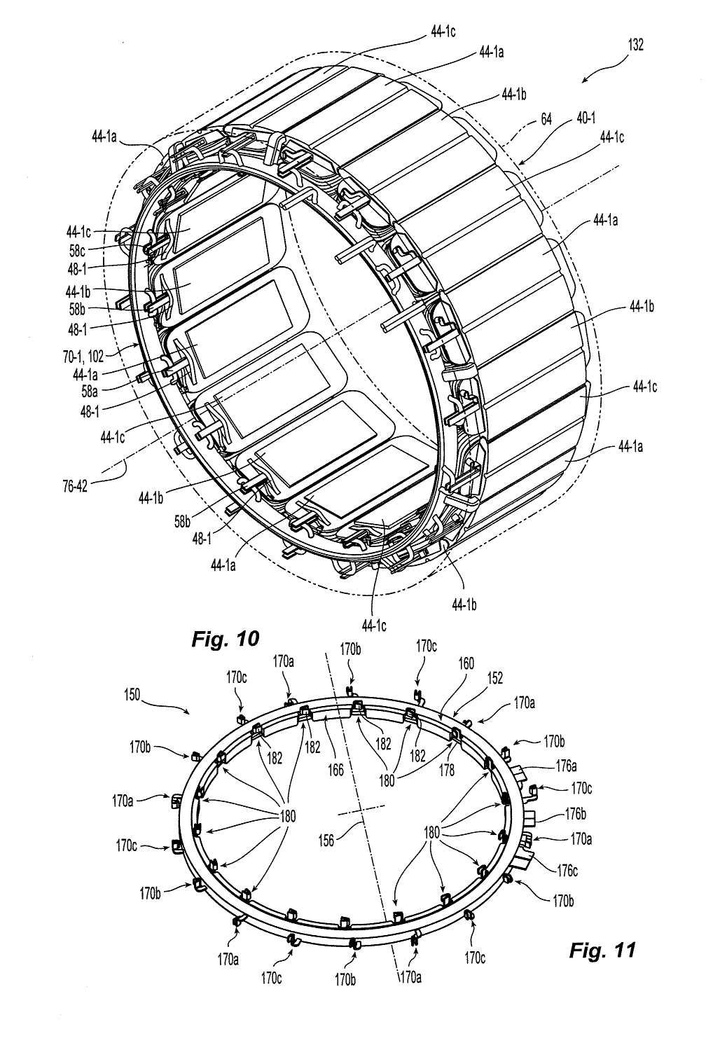

Referring to FIGS. 9B and 10, subassembly 132-1 includes the arranged plurality 40-1 of individual coil winding assemblies 44-1, the stator housing 64, and the buss bar assembly 70-1 in its registered position 102. The buss bar assembly 70 or 70-1, once in its registered position 102 may be additionally retained to the arranged plurality 40, 40-1 of coil winding assemblies 44, 44-1 and/or the stator housing 64 by any suitable retention means, which are not herein described and are beyond the scope of the present disclosure. One example retention method, however, is disclosed in related U.S. patent application Ser. No. 13/557,890, the disclosure of which incorporated herein by reference above.

Regardless of whether buss bar assembly 70 or 70-1 is used, once registered, the buss bar assembly is radially and axially positioned relative to the coil winding assembly arrangement 40 or 40-1. Further, it is envisioned that, if desired, the angular orientation of the buss bar assembly 70, 70-1 about the stator central axis 42 may optionally vary between any of the eighteen different positions at which the support legs 108 can abuttingly engage surfaces 110, the position of the phase power terminals 100 perhaps being most determinative of a preferred angular orientation of the buss bar assembly 70, 70-1 relative to its coil winding assembly arrangement 40, 40-1. Thus, as mentioned above, the characterization of a coil winding assembly 44, 44-1 as a first, second, or third phase coil winding assembly 44a, 44-1a; 44b, 44-1b; or 44c, 44-1c may not be necessarily predetermined.

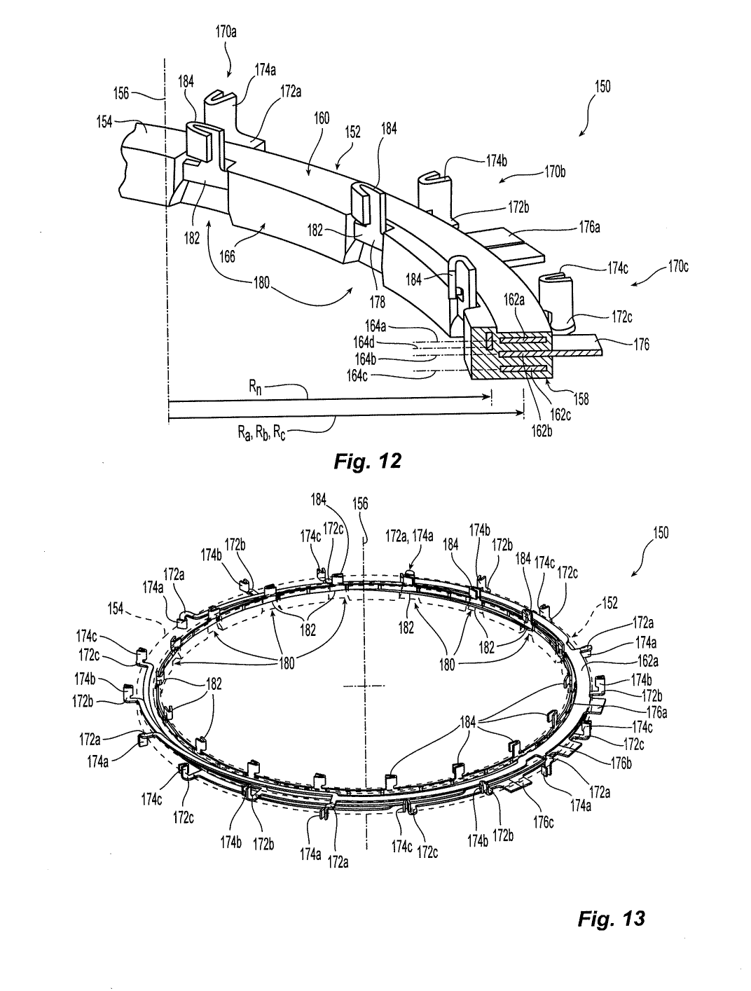

Referring to FIGS. 11-13, third embodiment buss bar assembly 150 has a dielectric, injection molded thermoplastic body 152 defining a substantially annular housing 154. Housing 154 defines a buss bar central axis 156, and has an inner face 158 and an axially opposed outer face 160. Buss bar assembly 150 includes a plurality of axially stacked phase bars 162 at least partially disposed within the buss bar body 152. Phase bars 162 are themselves mold inserts about which the plastic body 152 is overmolded. The substantially identical first, second, and third phase bars 162a, 162b, 162c are substantially concentric about the buss bar central axis 156 and located at radii Rₐ, R_{b}, and R_{c}, respectively, which are substantially equivalent. In the depicted embodiment, the phase bars 162a, 162b, 162c are stamped sheet metal material each formed into a substantially annular shape, and substantially lie in respective, parallel, spaced imaginary planes 164a, 164b, 164c that are perpendicular to the buss bar central axis 156.

Substantially annular buss bar body 152 or housing 154 includes a radially inner exterior surface 166 and a radially outer exterior surface 168. About the radially outer surface 168 are eighteen angularly distributed locations 170 of phase bar electrical contacts 172 electrically engageable from outside of the buss bar body 152. In the depicted embodiment, the electrical contacts 172 are integral with their respective phase bars 162, and formed from the same stamped sheet metal material. Each of the phase bars 162a, 162b, and 162c is associated with a plurality of contacts 172a, 172b, and 172c, respectively. Locations 170a, 170b, and 170c are where the first, second, and third phase bar electrical contacts 172a, 172b, and 172c, respectively, superpose the buss bar body 152 or housing 154. These locations 170 are, as in the first and second embodiment buss bar assemblies 70, 70-1, distributed at 20° intervals about buss bar body central axis 156. The phase bars 162 are electrically engageable through their respective contacts 172 from outside of the body 152 of the buss bar assembly 150. At each of locations 170 a phase bar electrical connection terminal 174 is in electrical communication with the phase bar electrical contact 172. In the depicted embodiment, terminals 174a, 174b, and 174c are integral with their respective contacts 172 and phase bars 162, and formed from the same stamped sheet metal material.

As best shown in FIG. 13, phase power terminals 176 are provided by which electrical power to or from the coil winding assemblies (not shown) is transferred to or from the buss bar assembly 150, as the case may be. In the present embodiment, the phase power terminals 176 are integral with their respective phase bars 162, and formed from the same stamped sheet metal material. The first, second, and third phase power terminals 176a, 176b, and 176c, respectively, may, for example, be angularly spaced from each other by either 20° or 40° about the buss bar central axis 156, and extend radially through the buss bar body or housing surface 168. Alternatively, the locations at which the phase power terminals 176 extend from the body 168 may be radially aligned relative to the central axis 156 and spaced axially therealong, preferably at a location circumferentially centered between a pair of adjacent contacts, in a manner similar to that shown in FIG. 5C.

Buss bar assembly 150 optionally includes a substantially annular neutral bar 178 of stamped sheet metal material formed into a short cylinder that may be substantially concentrically located about the buss bar central axis 156 at radius Rₙ, which is relatively smaller than radii Rₐ, R_{b}, or R_{c}. The plastic body 152 is overmolded about the neutral bar 178, as it is about the phase bars 162. As shown, the neutral bar 178 lies in a least one of planes 164a, 164b, and 164c, but may alternatively exclusively lie in its own, dedicated fourth imaginary plane (not shown) axially spaced from the others.

At equiangularly spaced locations 180 about the buss bar body 152, there are superposed neutral bar electrical contacts 182 in electrical communication with the neutral bar 178. Each contact 182 is provided with a neutral bar connection terminal 184. In the depicted embodiment, the electrical contacts 182 and its respective terminal 184 are integral with the neutral bar 178, and are formed from the same stamped sheet metal material. It is to be understood that the inclusion the neutral bar 178 and its associated electrical contacts 182 and connection terminals 184 is optional, and may be omitted from certain variants (not shown) of the second embodiment buss bar assembly 150. In such alternative configurations, extended portions of the second, neutral leads of each individual coil winding assembly (not shown) may extend circumferentially about the stator central axis in a manner similar to that shown in FIG. 3A, and interconnected externally of the third embodiment buss bar assembly 150. In the depicted embodiment, however, eighteen locations 180 of neutral bar electrical contacts 182, through which the neutral bar 178 is electrically engageable from outside of the body 152, are distributed about the radially inner surface 166 of the substantially annular buss bar body 152 or housing 154. During registration, as the arranged plurality of coil winding assemblies (not shown) and the buss bar assembly 150 relatively move towards each other with their respective central axes substantially coincident, the phase bar and neutral bar terminals 174 and 184 receive a corresponding phase lead or neutral lead terminal (not shown), and are subsequently crimped to them once the buss bar assembly 150 is in its registered position.

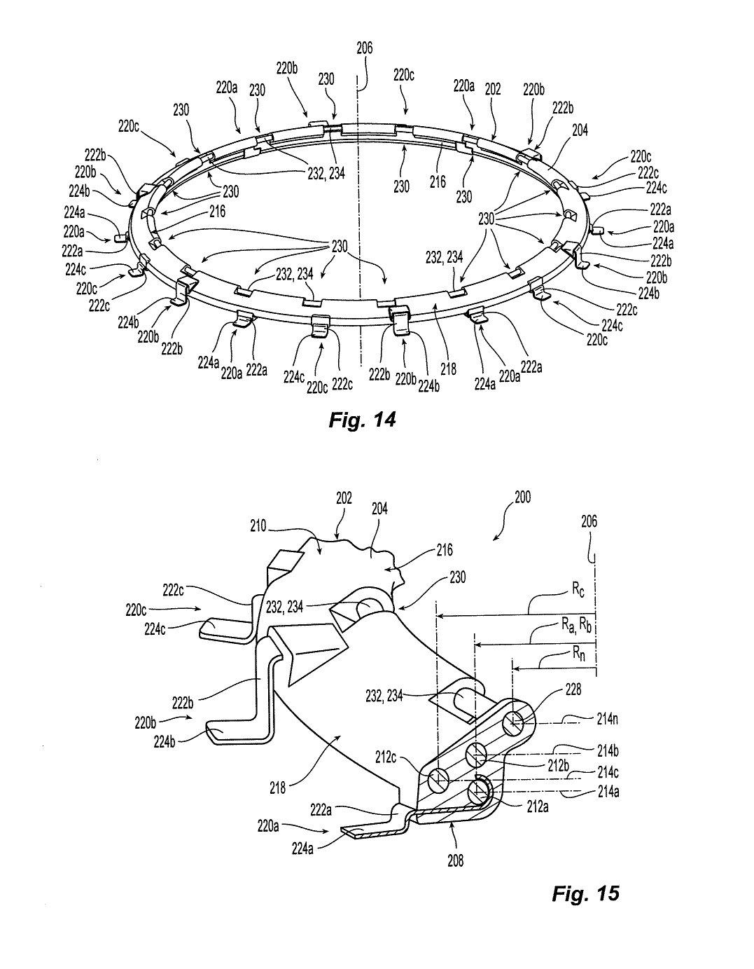

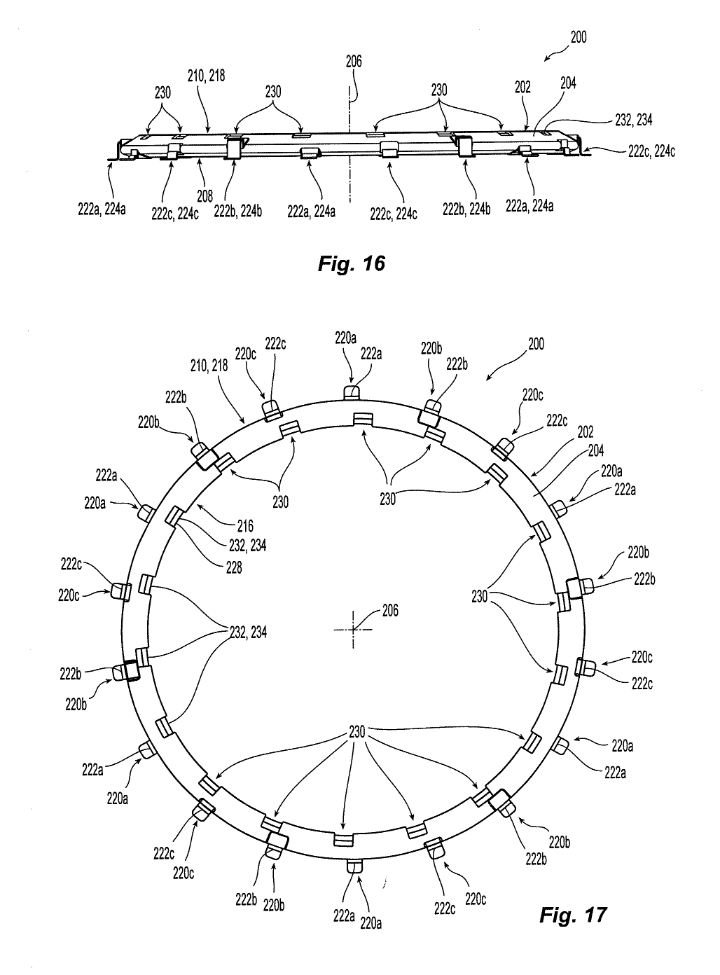

Referring to FIGS. 14-17, fourth embodiment buss bar assembly 200 has a dielectric, injection molded thermoplastic body 202 defining a substantially annular housing 204. Housing 204 defines a buss bar central axis 206 and has an inner face 208 and an axially opposed, oblique outer face 210. Buss bar assembly 200 includes a plurality of phase bars 212 at least partially disposed within the buss bar body 202. Phase bars 202 are themselves mold inserts about which body 202 is overmolded. As best understood from FIGS. 15 and 17, the first, second, and third phase bars 212a, 212b, 212c are substantially concentric about the buss bar central axis 206 and distanced therefrom at radii Rₐ, R_{b}, and R_{c}, respectively. In the depicted embodiment, the phase bars 212 are round wire material each formed into a substantially annular shape. Phase bars 212a, 212b, and 212c substantially lie in first, second, and third parallel imaginary planes 214a, 214b, and 214c, respectively, that are spaced along and perpendicular to the buss bar central axis 206.

Substantially annular buss bar body 202 or housing 204 includes a generally radial inner surface 216 and an oblique, generally radial outer surface 218. About the buss bar central axis 206 are eighteen angularly distributed locations 220 of phase bar electrical contacts 222 electrically engageable from outside of the buss bar body 202 or housing 204. Each of the phase bars 212a, 212b, and 212c is associated with a plurality of contacts 222a, 222b, and 222c, respectively. Locations 220a, 220b, and 220c are where the first, second, and third phase bar electrical contacts 222a, 222b, and 222c, respectively, superpose the buss bar body 202 or housing 204. These locations 220 are, as in the first and second embodiment buss bar assemblies 70, 70-1, distributed at 20° intervals about the buss bar central axis. The phase bars 212 are thus electrically engageable through their respective contacts 222 from outside of the body 202 of the buss bar assembly 200. At each of locations 220 a phase bar electrical connection terminal 224 is in electrical communication with the phase bar electrical contact 222. First, second, and third phase bar electrical terminals 224a, 224b, 224c are integrally formed with the phase bar electrical contacts 222a, 222b, 222c. In the depicted embodiment, the contacts 222 and terminals 224 are connected to their respective phase bar 212 internally of the body 202.

The fourth embodiment buss bar assembly 200 optionally includes phase power terminals (not shown) by which electrical power to or from the coil winding assemblies is transferred to or from the buss bar assembly 200, as the case may be. As in the previously discussed embodiments, the first, second, and third phase power terminals may, if included, be angularly spaced from each other by either 20° or 40° about the buss bar central axis 206. Alternatively, the locations at which the phase power terminals extend from the body 202 may be radially aligned relative to the central axis 206 and spaced axially therealong, preferably at a location circumferentially centered between a pair of adjacent contacts, in a manner similar to that shown in FIG. 5C.

Buss bar assembly 200 optionally includes a substantially annular neutral bar 228, of round wire construction similar to that of the phase bars 212, that may be substantially concentrically located about the buss bar central axis 206 at radius Rₙ, as shown in FIGS. 15 and 17. Radius Rₙ is relatively smaller than radii Rₐ, R_{b}, or R_{c}, and neutral bar 228 substantially lies in a fourth imaginary plane 214n that is parallel with planes 214a, 214b, and 214c, and spaced axially outwardly of these planes.

In buss bar assembly 200, electrical communication with the neutral bar 228 can be had from outside of the buss bar body 202 via superposed neutral bar electrical contacts 232 at locations 230 about the buss bar central axis 206. The locations 230 of the neutral bar electrical contacts 232 are along both the generally radial inner and outer surfaces 216 and 218. The neutral bar contacts 232 are defined by circumferentially extending portions of the neutral bar 228 in recesses formed in the body 204. As depicted, in buss bar assembly 200 these circumferentially extending portions define equiangularly distributed neutral bar electrical connection terminals 234. In the depicted embodiment the neutral bar electrical contacts 232 and connection terminals 234 are integral with the neutral bar 228. It is to be understood that the inclusion of the neutral bar 228 and its associated electrical contacts 232 and connection terminals 234 is optional, and may be omitted from certain variants (not shown) of the fourth embodiment buss bar assembly 200. In such alternative configurations, extended portions of the second, neutral leads of the individual coil winding assemblies (not shown) may extend circumferentially about the stator central axis in a manner similar to that shown in FIG. 3A, and be interconnected externally of the fourth embodiment buss bar assembly 200. In the depicted embodiment, however, eighteen locations 230 of neutral bar electrical contacts 232 are provided through which the neutral bar 228 is electrically engageable from outside of the body 202, by neutral lead terminals (not shown) that may be similar to terminals 58 shown in FIG. 3B. During registration, as the arranged plurality of coil winding assemblies (not shown) and the buss bar assembly 200 relatively move towards each other with their respective central axes substantially coincident, the phase bar and neutral bar terminals 224 and 234 engage a corresponding phase lead or neutral lead terminal (not shown), and are held in engagement in the buss bar assembly 200 registered position.

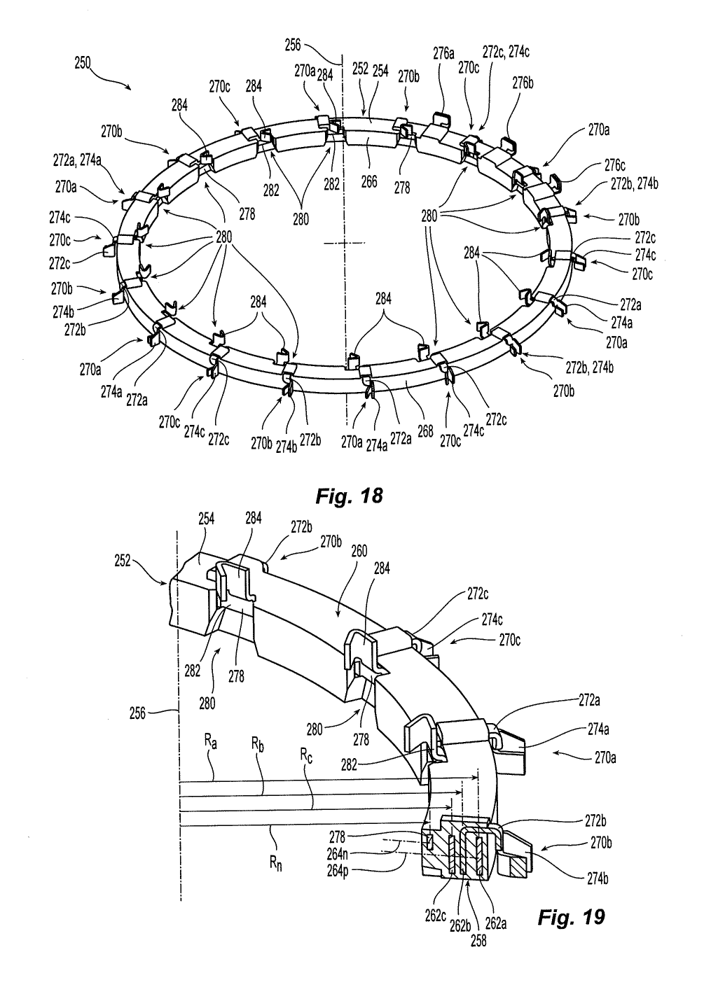

Referring to FIGS. 18-21, fifth embodiment buss bar assembly 250 has a dielectric, injection molded thermoplastic body 252 defining a substantially annular housing 254. Housing 254 defines buss bar central axis 256, and has an inner face 258 and an axially opposed outer face 260. Buss bar assembly 250 includes a plurality of phase bars 262 at least partially disposed within the buss bar body 252. The phase bars 262 are themselves mold inserts about which body 252 is overmolded. As shown in FIG. 19, the first, second, and third phase bars 262a, 262b, 262c are substantially concentric about the buss bar central axis 256 and located therefrom at radii Rₐ, R_{b}, and R_{c}, respectively. In the depicted embodiment, the phase bars 262 are stamped sheet material each formed into a short cylinder, and substantially lie in parallel first, second, and third imaginary planes 264a, 264b, and 264c, respectively, that are perpendicular to buss bar central axis 256. As shown, planes 264a, 264b, and 264c may be co-located along axis 256, although they may instead be spaced therealong.

Substantially annular buss bar body 252 or housing 254 includes a radially inner exterior surface 266 and a radially outer exterior surface 268. About the buss bar central axis 256 are angularly distributed locations 270 of phase bar electrical contacts 272 electrically engageable from outside of the buss bar body 252 or housing 254. Each of the phase bars 262a, 262b, and 262c is associated with a plurality of contacts 272a, 272b, and 272c, respectively. Locations 270a, 270b, and 270c are where the first, second, and third phase bar electrical contacts 272a, 272b, and 272c, respectively, superpose the buss bar body 252 or housing 254. These locations 270 are, as in the first and second embodiment buss bar assemblies 70, 70-1, distributed at 20° intervals about the buss bar central axis 256. At each of locations 270 a phase bar electrical connection terminal 274 is in electrical communication with the phase bar electrical contact 272. The phase bars 262 are thus electrically engageable through their respective contacts 272 and terminals 274 from outside of the body 252 or housing 254 of the buss bar assembly 250. The first, second, and third phase bar electrical terminals 274a, 274b, 274c are connected to phase bar electrical contacts 272a, 272b, 272c at locations 270a, 270b, 270c, respectively. In the depicted embodiment, contacts 272 and terminals 274 are integral with their respective phase bar 262, and formed from the same sheet metal material.

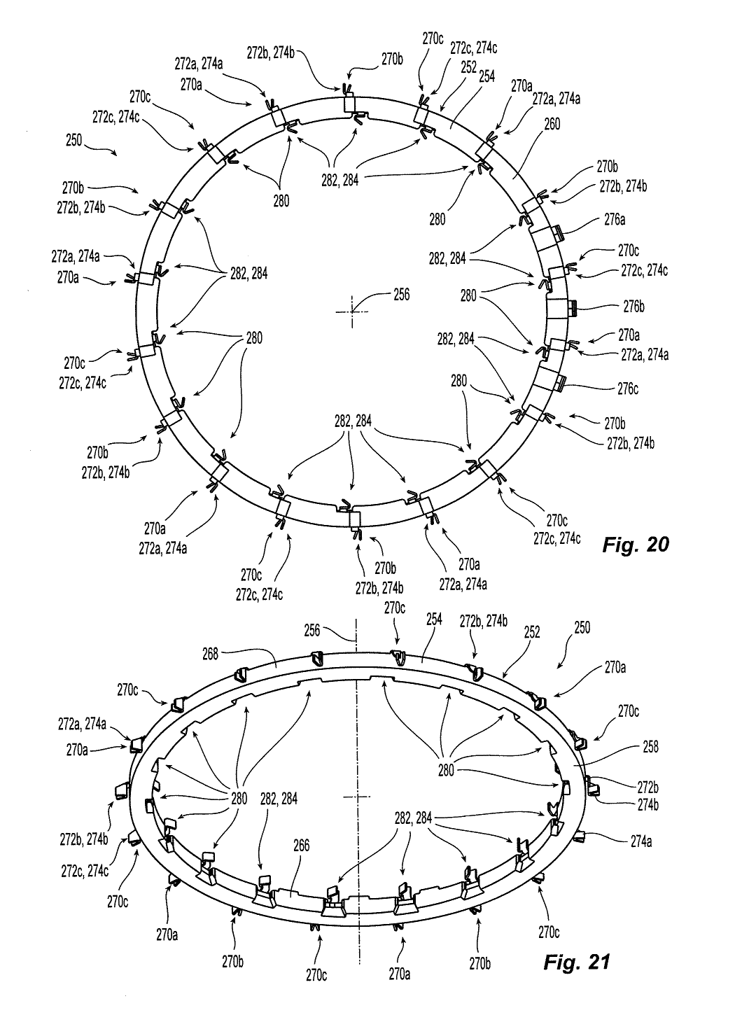

As best shown in FIGS. 18 and 20, phase power terminals 276 are provided by which electrical power to or from the coil winding assemblies is transferred to or from the buss bar assembly 250, as the case may be. Each phase power terminal 276 is integral with its respective phase bar 262, and formed from the same sheet metal material. The first, second, and third phase power terminals 276a, 276b, and 276c, respectively, may, for example, be angularly spaced from each other by either 20° or 40° about the buss bar central axis 256, and extend radially outwardly from radially outer surface 268. Alternatively, the locations at which the phase power terminals 276 extend from the body 252 may be radially aligned relative to the central axis 256 and spaced axially therealong, preferably at a location circumferentially centered between a pair of adjacent contacts, in a manner similar to that shown in FIG. 5C.

Buss bar assembly 250 optionally includes a substantially annular neutral bar 278 of construction similar to that of the phase bars 262 and may be substantially concentrically located about the buss bar central axis 256 at radius Rₙ, as shown in FIG. 19. Radius Rₙ is relatively smaller than radii Rₐ, R_{b}, or R_{c}. Neutral bar 278 substantially lies in fourth imaginary plane 264n that is parallel with planes 264a, 264b, and 264c, and may be co-located therewith as shown, or instead spaced therefrom along buss bar central axis 256. Body 252 is also overmolded about neutral bar 278.

The depicted embodiment includes eighteen equiangularly spaced locations 280 about the buss bar central axis 256 at which are neutral bar electrical contacts 282 through which the neutral bar 278 is electrically engageable from outside of the buss bar body 252 or housing 254. At each of the neutral bar contact locations 280 is a neutral bar electrical connection terminal 284 connected to the respective contact 282. In the depicted embodiment, the neutral bar electrical contacts 282 and connection terminals 284 are integral with the neutral bar 278, and formed from the same sheet metal material. It is to be understood that the inclusion the neutral bar 278 and its associated contacts 282 and connection terminals 284 is optional, and may be omitted from certain variants (not shown) of the fifth embodiment buss bar assembly 250. In such alternative configurations, extended portions of the second, neutral leads of each individual coil winding assembly may extend circumferentially about the stator central axis in a manner similar to that shown in FIG. 3A, and interconnected externally of the fifth embodiment buss bar assembly 250.

Referring to the fifth embodiment buss bar assembly 250 as depicted, during registration, as the arranged plurality of coil winding assemblies (not shown) and the buss bar assembly relatively move towards each other with their respective central axes substantially coincident, the phase bar and neutral bar terminals 274 and 284 receive a corresponding phase lead or neutral lead terminal (not shown), and are subsequently crimped to them once the buss bar assembly 250 is in its registered position.

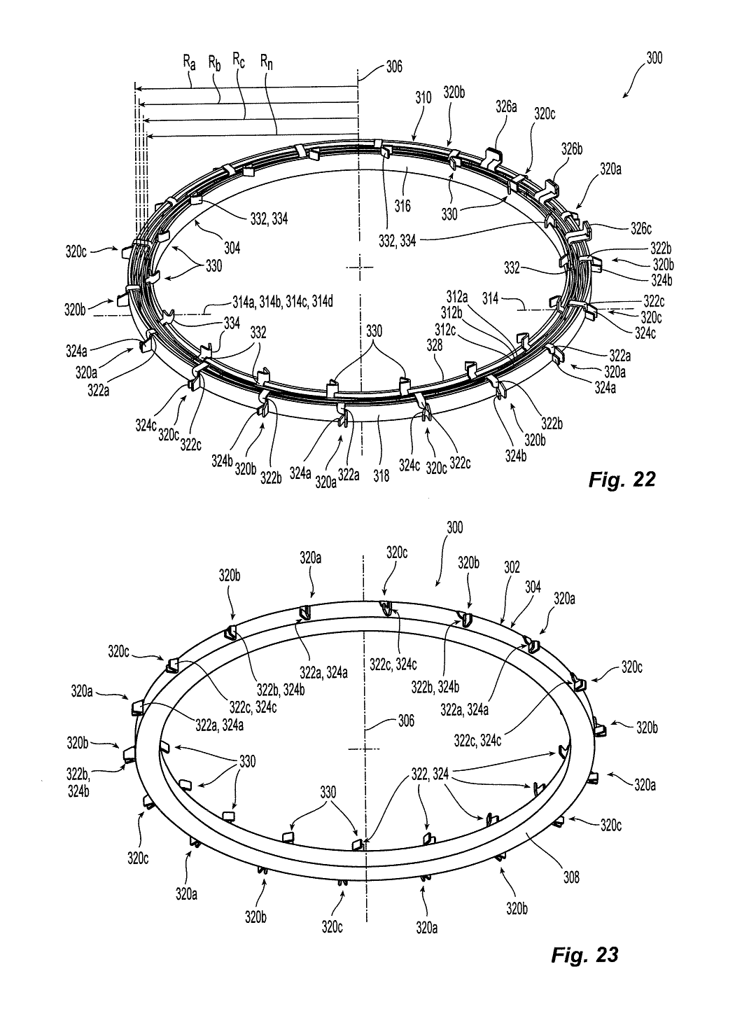

Referring to FIGS. 22 and 23, sixth embodiment buss bar assembly 300 has a dielectric, injection molded thermoplastic body 302 defining a substantially annular housing 304. Housing 304 defines buss bar central axis 306, and has an inner face 308. Buss bar assembly 300 includes a plurality of phase bars 312 at least partially disposed within the buss bar body 302 and substantially lie in respective first, second, and third parallel imaginary planes 314a, 314b, and 314c that are perpendicular to buss bar central axis 306. Planes 314a, 314b, and 314c may be co-located as shown, or instead spaced along the axis 306. In the depicted embodiment, the phase bars 312 are stamped sheet material each formed into a short cylinder. As shown in FIG. 22, the first, second, and third phase bars 312a, 312b, 312c are substantially concentric about the buss bar central axis 306 and located at radii Rₐ, R_{b}, and R_{c}, respectively.

Substantially annular buss bar housing 304 includes a radially inner exterior surface 316 and a radially outer exterior surface 318. About the buss bar central axis 306 are eighteen equiangularly spaced locations 320 of phase bar electrical contacts 322 that are electrically engageable from outside of the buss bar body 302 or housing 304. Each of the phase bars 312a, 312b, and 312c is associated with a plurality of contacts 322a, 322b, and 322c, respectively. Locations 320a, 320b, and 320c are where the first, second, and third phase bar electrical contacts 322a, 322b, and 322c, respectively, superpose the buss bar body 302. These locations 320 are, as in the first and second embodiment buss bar assemblies 70, 70-1, distributed at 20° intervals about the buss bar central axis 306. At each of locations 320 a phase bar electrical connection terminal 324 is in electrical communication with the phase bar electrical contact 322. In the depicted embodiment, contacts 322 and terminals 324 are integral with their respective phase bar 312, and formed from the same sheet metal material. The first, second, and third phase bar electrical terminals 324a, 324b, 324c are connected to phase bar electrical contacts 322a, 322b, 322c at locations 320a, 320b, 320c, respectively. The phase bars 312 are electrically engageable through their respective contacts 322 from outside of the body 302 or housing 304 of the buss bar assembly 300.

As best shown in FIG. 22, phase power terminals 326 are optionally provided by which electrical power to or from the coil winding assemblies is transferred to or from the buss bar assembly 300, as the case may be. The first, second, and third phase power terminals 326a, 326b, and 326c, respectively, may, for example, be angularly spaced from each other by either 20° or 40° about the buss bar central axis 306, and formed of the same sheet metal material of the phase bars 312, and thus be integral therewith. As shown, the phase power terminals 326 extend radially outwardly from radially outer exterior surface 318. Alternatively, the locations at which the phase power terminals 326 extend from the body 302 may be radially aligned relative to the central axis 306 and spaced axially therealong, preferably at a location circumferentially centered between a pair of adjacent contacts, in a manner similar to that shown in FIG. 5C.

Buss bar assembly 300 optionally includes a substantially annular neutral bar 328 of construction similar to that of the phase bars 312 and may be substantially concentrically located about the buss bar central axis 306 at radius Rₙ, as shown in FIG. 22. Radius Rₙ is relatively smaller than radii Rₐ, R_{b}, or R_{c}, and the neutral bar 328 substantially lies in a fourth imaginary plane 314n that is parallel with planes 314a, 314b, and 314c, and may be co-located therewith as shown, or instead spaced therefrom along buss bar central axis 306. In the depicted embodiment, eighteen locations 330 of neutral bar electrical contacts 332 through which the neutral bar 328 is electrically engageable are distributed about the buss bar central axis 306. At each of the neutral bar contact locations 330 is a neutral bar electrical connection terminal 334 connected to the respective contact 332. In the depicted embodiment, the neutral bar electrical contacts 332 and connection terminals 334 are integral with the neutral bar 328. The neutral bar connection terminals 334 extend radially inwardly from radially inner surface 316 of body 302 or housing 304. The terminals 334 and contacts 332, and thus the neutral bar 328, are electrically engageable from outside of the buss bar body 302 or housing 304.

It is to be understood that the inclusion of the neutral bar 328 and its associated contacts 332 and connection terminals 334 is optional, and may be omitted from certain variants (not shown) of the sixth embodiment buss bar assembly 300. In such alternative configurations, extended portions of the second, neutral leads of each individual coil winding assembly (not shown) may extend circumferentially about the stator central axis in a manner similar to that shown in FIG. 3A, and interconnected externally of the sixth embodiment buss bar assembly 300.

Once the phase bars 312 and neutral bar 328 are positioned in body 302, a dielectric, thermally conductive liquid resin (not shown) of a suitable type known to those of ordinary skill in the art is poured into its U-shaped channel, and between and over the substantially concentric radially inner and outer walls of the body 302, the phase bars 312, and the neutral bar 328. The resin subsequently cures and becomes attached to the body 302, thereby maintaining electrical isolation between the phase bars 312 and fixing their positions relative to the housing 304. The thermally conductive resin promotes heat transfer from the buss bars, which may facilitate higher loading of a motor and consequent performance improvements vis-à-vis buss bar assemblies whose bodies are made of relatively less thermally conductive dielectric materials. The cured resin also becomes the portion of the body 302 that defines its outer face 310, which is axially opposed to inner face 308. The attachment of the resin to the remainder of body 302 may be through adhesion and/or mechanically as described in U.S. Provisional Patent Application Ser. No. 61/670,473, the disclosure of which is incorporated herein by reference above.

During registration, as the arranged plurality of coil winding assemblies (not shown) and the buss bar assembly 300 relatively move towards each other with their respective central axes substantially coincident, the phase bar and neutral bar terminals 324 and 334 receive a corresponding phase lead or neutral lead terminal (not shown), and are subsequently crimped to them once the buss bar assembly 300 is in its registered position.

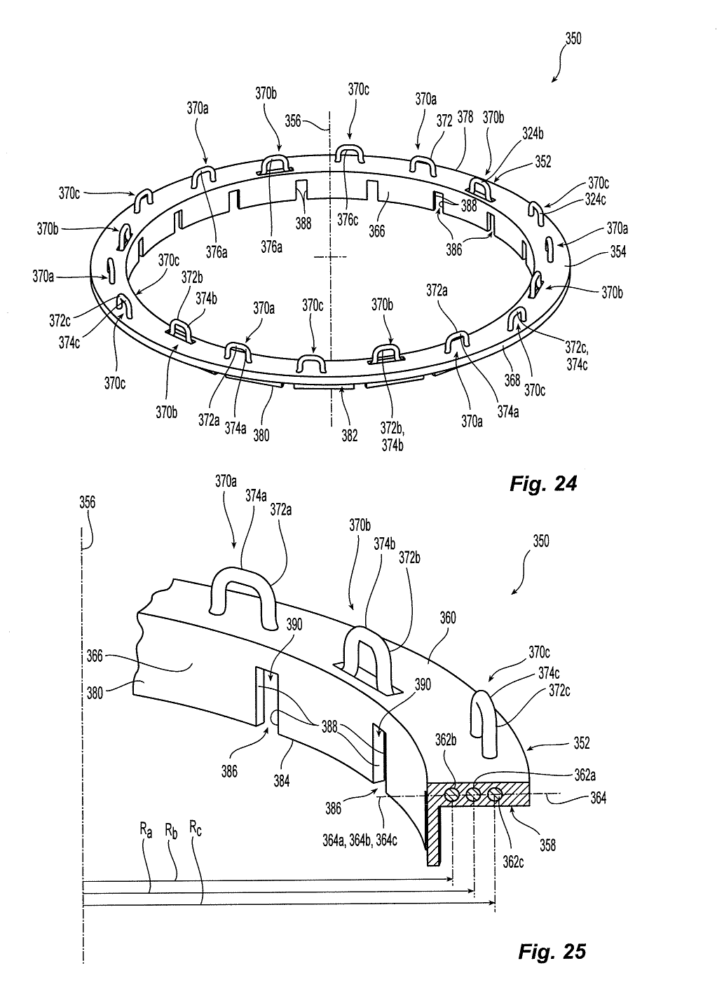

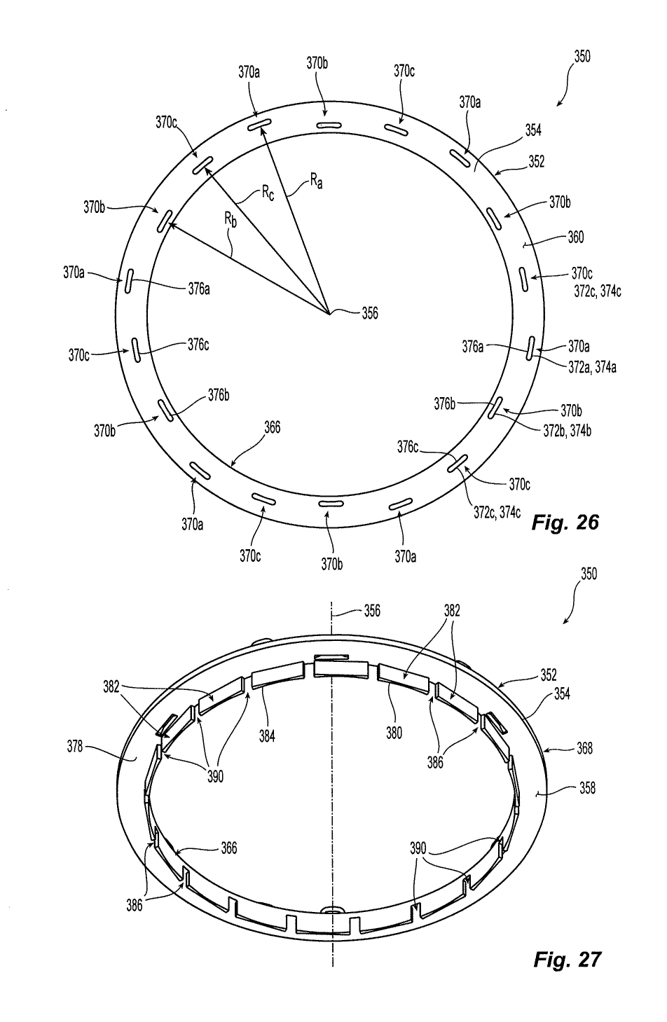

Referring to FIGS. 24-27, seventh embodiment buss bar assembly 350 has a dielectric, injection molded thermoplastic body 352 defining a substantially annular housing 354. Housing 354 defines a buss bar central axis 356, and has an inner face 358 and an axially opposed outer face 360. Buss bar assembly 350 includes first, second, and third phase bars 362a, 362b, and 362c that are at least partially disposed within the buss bar body 352 or housing 354. The phase bars 362 themselves are mold inserts about which the plastic body 352 is overmolded. Phase bars 362a, 362b, and 362c substantially lie in parallel imaginary planes 364a, 364b, 364c, respectively, that are perpendicular to the buss bar central axis 356. Planes 364a, 364b, and 364c may, as shown, be co-located. As best shown in FIGS. 25 and 26, the first, second, and third phase bars 362a, 362b, 362c are substantially concentric about the buss bar central axis 356 and located at radii Rₐ, R_{b}, and R_{c}, respectively. In the depicted embodiment, the phase bars 362a, 362b, 362c are each of round wire material formed into a substantially annular shape, and having a plurality of circumferentially-extending portions 376a, 376b, 376c, respectively, that project axially outwardly from planes 364 and outer face 360.

Substantially annular buss bar body 352 or housing 354 includes a planar, circular flange portion 378 that lies in imaginary plane 364, contains the portions of phase bars 362 located between circumferentially-extending portions 376, and is disposed between radially inner and radially outer exterior surfaces 366 and 368, respectively, of the body 352 or housing 354. Depending axially inwardly from flange portion 378, and partially defining radially inner surface 366, is cylindrical skirt portion 380. Skirt portion 380 has a radially outer exterior surface 382 located radially inward of body radially outer exterior surface 368, and partially defines body radially inner exterior surface 366. Skirt portion 380 has an axially inward circular edge 384 in which axially-extending, open-ended slots 386 defined by circumferentially opposed sides 388 are equiangularly distributed about buss bar central axis 356.

The axially projecting phase bar portions 376 are located on the body outer face 360 at eighteen angularly spaced locations 370 relative to the buss bar central axis 356, where they define phase bar electrical contacts 372 electrically engageable from outside of the buss bar body 352. Each of the phase bars 362a, 362b, and 362c is associated with a plurality of contacts 372a, 372b, and 372c, respectively, at locations 370a, 370b, and 370c. These locations 370 are, as in the first and second embodiment buss bar assemblies 70, 70-1, distributed at 20° intervals about the buss bar central axis 356, and at each of locations 370 a phase bar electrical connection terminal 374 is in electrical communication with the phase bar electrical contact 372. The first, second, and third phase bar electrical terminals 374a, 374b, 374c are integral with the phase bar electrical contacts 372a, 372b, 372c at locations 370a, 370b, 370c, respectively. Thus, in the depicted embodiment, contacts 372 and terminals 374 are integral with their respective phase bar 362, and defined by circumferentially-extending portions 376. The phase bars 362 are thus electrically engageable through their respective contacts 372 from outside of the body 352 or housing 354 of the buss bar assembly 350.

Phase power terminals (not shown) may be optionally provided by which electrical power to or from the coil winding assemblies is transferred to or from the buss bar assembly 350, as the case may be. The first, second, and third phase power terminals may, if provided, be angularly spaced from each other by either 20° or 40° about the buss bar central axis 356. Alternatively, the locations at which the phase power terminals extend from the body 352 may be radially aligned relative to the central axis 356 and spaced axially therealong, preferably at a location circumferentially centered between a pair of adjacent contacts, in a manner similar to that shown in FIG. 5C.

Buss bar assembly 350 may also optionally include a substantially annular neutral bar (not shown) of round wire construction similar to that of the phase bars 362 and may be substantially concentrically located about the buss bar central axis 356. The neutral bar may also substantially lie in imaginary plane 364 at a radius Rₙ (not shown) that is smaller than radii Rₐ, R_{b}, and R_{c}, and also within housing flange portion 378. The neutral bar's contacts and/or terminals (not shown) may extend radially inwardly from body radially inner surface 366, and be defined by circumferentially extending and radially-inwardly projecting portions of the neutral bar, in the manner of above-described neutral bar 120 of the second embodiment buss bar assembly 70-1. It is to be understood that the inclusion of a neutral bar and its associated electrical contacts and connection terminals in the seventh embodiment buss bar assembly 350 is optional, and may be included in certain variants (not shown) thereof. For use with such alternative configurations, the second, neutral leads of each individual coil winding assembly (not shown) may be provided with a neutral lead terminal that extends in an axial direction relative to the stator central axis, in a manner similar to terminals 58 shown in FIG. 3B, and interconnected internally of the seventh embodiment buss bar assembly 350.

During registration, as the arranged plurality of coil winding assemblies (not shown) and the buss bar assembly 350 relatively move towards each other with their respective central axes substantially coincident, each slot 386 may slidably receive one of a circularly arranged set of cooperating, axially-extending features (not shown) provided on the arranged plurality of coil winding assemblies (not shown) about the stator axis and, in the registered position (not shown) of the seventh embodiment buss bar assembly 350, circular edge 384 may abut a corresponding surface (not shown) on the coil winding assemblies. Thus, predetermined radial and axial positions of buss bar assembly 350 can be established relative to an arranged plurality of coil winding assemblies when mutually registered with each other, with slots 386 defining a pilot feature 390 by which the buss bar assembly 350 is guided towards its registered position. The phase lead terminals (not shown) may be configured to be shifted into predetermined, connected positions in which they are engaged with a correspondingly aligned phase bar terminals 374, in the buss bar registered position. If present, the neutral lead terminals (not shown but which may be similar to terminals 58 of FIG. 3B) may be slidably engaged with aligned neutral bar terminals (not shown) that are similar to terminals 128 of second embodiment buss bar assembly 70-1, as the angularly aligned buss bar assembly 350 is moved axially into its registered position.

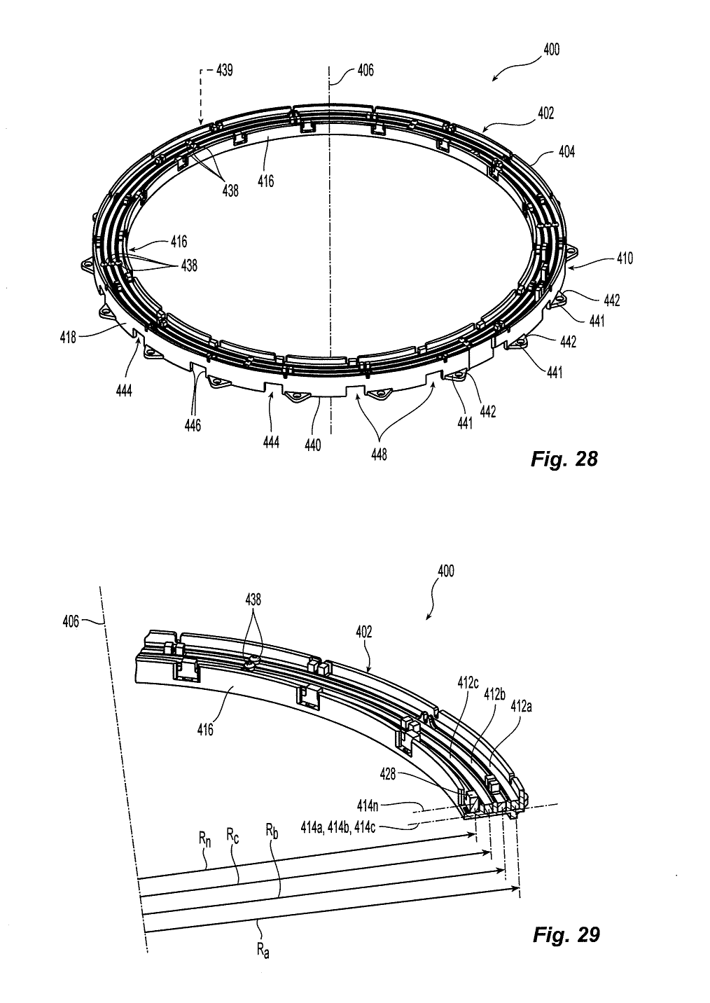

Referring to FIGS. 28-31, eighth embodiment buss bar assembly 400 has a body 402 defining a substantially annular housing 404. Housing 404 defines buss bar central axis 406, and has an inner face 408. The dielectric, injection molded thermoplastic buss bar body 402 also includes an integral support 410 that extends from the substantially annular housing 404 and by which the registered position of the buss bar assembly 400 relative to an arranged plurality of individual coil winding assemblies (not shown) is established, and by which they are retained to each other.

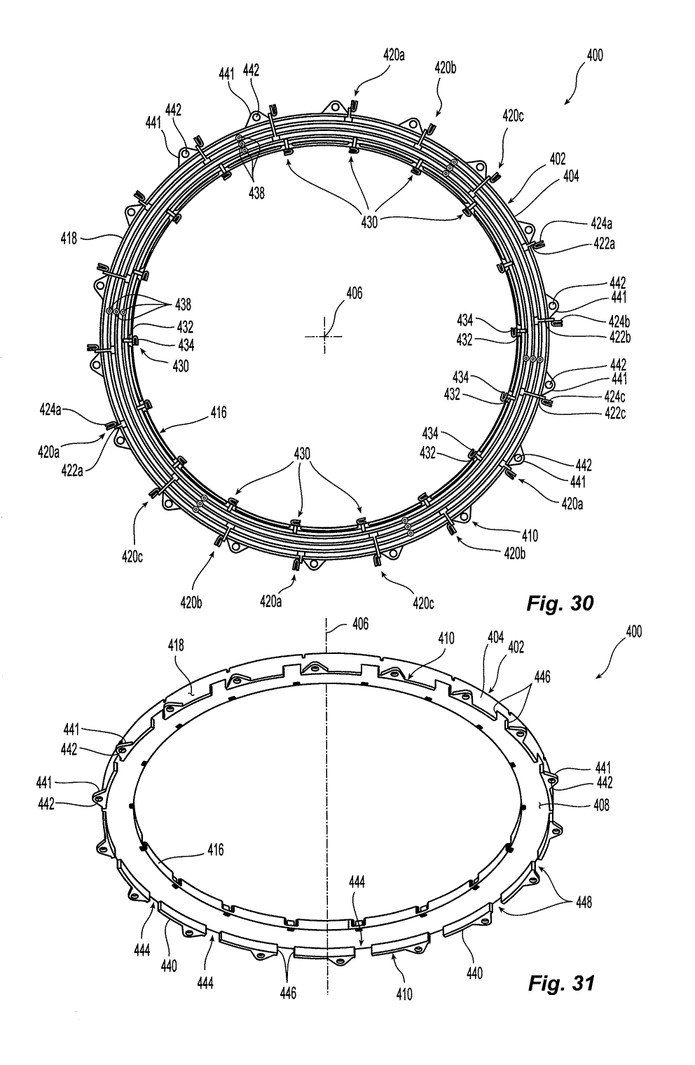

Buss bar assembly 400 includes a plurality of phase bars 412 at least partially disposed within the buss bar body 402. As shown in FIGS. 29 and 30, the first, second, and third phase bars 412a, 412b, 412c are substantially concentric about the buss bar central axis 406 and located at radii Rₐ, R_{b}, and R_{c}, respectively. In the depicted embodiment, the phase bars 412 are stamped sheet metal material each formed into a short cylinder, and substantially lie in respective first, second, and third parallel imaginary planes 414a, 414b, and 414c that are perpendicular to buss bar central axis 406. Planes 414a, 414b, and 414c may be co-located as shown.

Substantially annular buss bar housing 404 includes a radially inner exterior surface 416 and a radially outer exterior surface 418. About the radially outer surface 418 are eighteen angularly distributed locations 420 of phase bar electrical contacts 422 electrically engageable from outside of the buss bar body 402 or housing 404. Each of the phase bars 412a, 412b, and 412c is associated with a plurality of contacts 422a, 422b, or 422c, respectively. Locations 420 are, as in the first and second embodiment buss bar assemblies 70, 70-1, distributed at 20° intervals about the buss bar central axis 406. At each of locations 420 a phase bar electrical connection terminal 424 is in electrical communication with the phase bar electrical contact 422. In the depicted embodiment, the first, second, and third phase bar electrical terminals 424a, 424b, 424c are connected to phase bar electrical contacts 422a, 422b, 422c at locations 420a, 420b, 420c, respectively. The contacts 422 and terminals 424 are integral with their respective phase bar 412, and formed from the same sheet metal material. The phase bars 412 are thus electrically engageable through their respective electrical contacts 422 and connection terminals 424 from outside of the body 402 or housing 404 of the buss bar assembly 400.

Phase power terminals (not shown) may be optionally provided by which electrical power to or from the coil winding assemblies is transferred to or from the buss bar assembly 400, as the case may be. The first, second, and third phase power terminals, if present, may, for example, be angularly spaced from each other by either 20° or 40° about the buss bar central axis 406. Alternatively, the locations at which the phase power terminals extend from the body 402 may be radially aligned relative to the central axis 406 and spaced axially therealong, preferably at a location circumferentially centered between a pair of adjacent contacts, in a manner similar to that shown in FIG. 5C.

Buss bar assembly 400 optionally includes a substantially annular neutral bar 428 of construction similar to that of the phase bars 412. Neutral bar 428 may be substantially concentrically located about the buss bar central axis 406 at radius Rₙ that is smaller than radii Rₐ, R_{b}, R_{c} of the phase bars 412a, 412b, or 412c, respectively. Neutral bar 428 substantially lies in a fourth imaginary plane 414n that is parallel with planes 414a, 414b, and 414c, and may be spaced therefrom along buss bar central axis 406 as shown, or instead co-located with those planes.

In the depicted embodiment, eighteen locations 430 of neutral bar electrical contacts 432, through which the neutral bar 428 is electrically engageable are distributed about the buss bar central axis 406. At each of the neutral bar contact locations 430 is a neutral bar electrical connection terminal 434 connected to the respective contact 432. In the depicted embodiment, the neutral bar electrical contacts 432 and connection terminals 434 are integral with the neutral bar 428 and formed from the same sheet metal material. The neutral bar connection terminals 434 extend radially inwardly from the body radially inner surface 416. The terminals 434 and contacts 432, and thus the neutral bar 428, are electrically engageable from outside of the buss bar body 402 or housing 404. It is to be understood that the inclusion the neutral bar 428 and its associated contacts 432 and connection terminals 434 is optional, and may be omitted from certain variants (not shown) of the eighth embodiment buss bar assembly 400. In such alternative configurations, extended portions of the second, neutral leads of each individual coil winding assembly (not shown) may extend circumferentially about the stator central axis in a manner similar to that shown in FIG. 3A, and be interconnected externally of the buss bar assembly 400.

Housing 404 defines a U-shaped channel 436 having a floor in which are defined first, second, third, and fourth subchannels 437a, 437b, 437c, 437n in which the phase and neutral bars 412a, 412b, 412c, and 428 are respectively positioned and retained by pluralities of cylindrical retainers 438 integrally formed in the body 402 and distributed about the buss bar central axis 406. The retainers 428 are plastically deformed, as by known sonic or spin welding technologies, for example, to fix the phase and neutral bars 412, 428 within the subchannels 437. Once the phase bars 412 and neutral bar 428 are fixed to the body 402, a dielectric, thermally conductive liquid resin (not shown) of a suitable type known to those of ordinary skill in the art is poured into its U-shaped channel 436, between the substantially concentric radially inner and outer walls of the channel 436, and between and over the phase and the neutral bars 412, 428. The thermally conductive resin promotes heat transfer from the buss bars, which may facilitate higher loading of a motor and consequent performance improvements vis-à-vis buss bar assemblies whose bodies are made of relatively less thermally conductive dielectric materials. The resin subsequently cures and becomes attached to the body 402, and maintains electrical isolation of the phase and neutral bars 412, 428 within the housing 404. The buss bar assembly 400 is thus of the potted type, with the cured resin also becoming the portion of body 402 that defines its outer face 439, which is axially opposed to body inner face 408. The attachment of the resin to the remainder of body 402 may be through adhesion and/or mechanically as described in U.S. Provisional Patent Application Ser. No. 61/670,473, the disclosure of which is incorporated herein by reference above.

During registration, as the arranged plurality of coil winding assemblies (not shown) and the buss bar assembly 400 relatively move towards each other with their respective central axes substantially coincident, the phase bar and neutral bar terminals 424 and 434 receive a corresponding radially and axially aligned phase or neutral lead terminal (not shown).

Buss bar body support 410 includes a cylindrical skirt portion 440 that is aligned with and shares the body radially outer exterior surface 418. The support 410 also includes substantially planar legs 441 that extend radially outwardly from surface 418 at 20° intervals about the buss bar central axis 406. Each planar leg 441 has an aperture 442 therethrough. The support 410 further includes open-ended slots 444 extending axially along the body radially outer exterior surface 418. Each slot 444 is interposed between a pair of circumferentially adjacent legs 441, and is defined by a pair of circumferentially spaced edges 446 between which is received a coil winding assembly phase lead terminal (not shown), which becomes mated with a corresponding phase bar electrical connection terminal 424.

The opening defined by each slot 444 defines one of a plurality of pilot features 448 for radially orienting the buss bar assembly 400 to an arranged coil winding assembly (not shown). The slots 444 cooperate with phase lead terminals (not shown) received between the slot edges 446. The phase lead terminals are thus received features which cooperate with the pilot features 448. Although one may of course conversely consider the openings defined by slots 444 as received features 448, and the phase lead terminals (not shown) as pilot features over which the slots 444 are received, the former characterization is adopted in the present description. The buss bar assembly 400 is thus keyed to the stator (not shown) during its installation, and guided into a registered position by the cooperation between the slots 444 and the phase lead terminals received therein. The buss bar assembly 400 can thus be initially and quickly oriented for registration with a cooperating arranged plurality of individual coil winding assemblies. During registration, the phase and neutral lead terminals (not shown) are mated with their respective aligned phase bar and neutral bar connection terminals 424, 434. Once the buss bar assembly 400 and coil winding assembly arrangement are mutually registered, each pair of mated terminals is subsequently secured (perhaps after the buss bar assembly 400 itself has been retained to the stator) by crimping or soldering to ensure a reliable electrical connection therebetween.

A cylindrical pin (not shown) may be integrally provided on each over-molded thermoplastic insulator of the arranged plurality of coil winding assemblies (not shown). The cylindrical pins may extend in directions parallel with the stator central axis at discrete locations on the axially outward face of the coil winding assembly arrangement at which the legs 441 are seated upon registration. The apertures 442 in the buss bar support legs 441 are closely received over the cylindrical pins as the buss bar assembly 400 enters its registered position, subsequent to the phase lead terminals (not shown) being accepted into the slots 444. Once the legs 441 are fully received onto the pins and the support 410 has been seated onto the arranged plurality of coil winding assemblies, the buss bar assembly 400 is registered relative to the coil winding assembly arrangement. Once registered, the relative axial and radial positions of the buss bar assembly 400 and the coil winding assembly arrangement are established and the buss bar assembly 400 may be retained to the stator by plastically deforming the received ends of the thermoplastic pins to form a large diameter head which secures the buss bar support leg 441 to the coil winding assembly insulator. Deformation of the thermoplastic pin may be done, for example, by known sonic or spin welding techniques. The registered buss bar assembly 400 may thus be retained in its installed state. A similar support structure and buss bar assembly retaining process are disclosed in related U.S. patent application Ser. No. 13/557,890, the disclosure of which is incorporated herein by reference above.

The installation of the buss bar assembly 400 relative to a coil winding assembly arrangement thus lends itself to automated assembly processes.

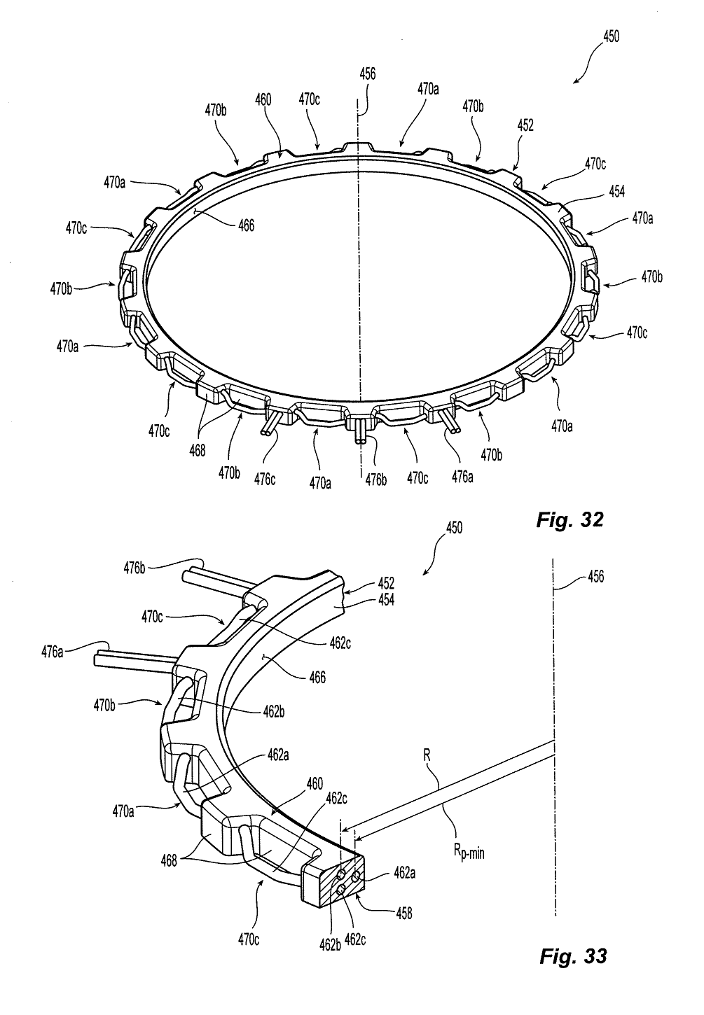

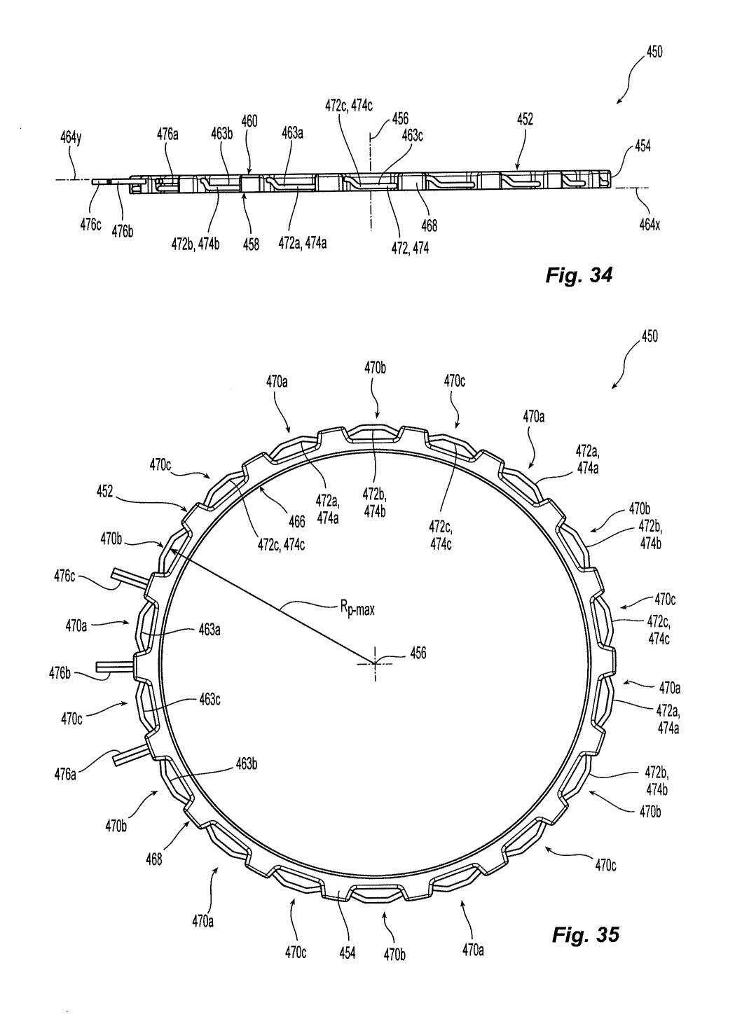

Referring to FIGS. 32-35, ninth embodiment buss bar assembly 450 has a dielectric, injection molded thermoplastic body 452 that includes a substantially annular housing 454 defining buss bar central axis 456, and having an inner face 458 and an axially opposed outer face 460. Buss bar assembly 450 includes a plurality of substantially annular phase bars 462 at least partially disposed within the buss bar body 452. Body 452 is overmolded about phase bars 462. As shown in FIGS. 33 and 35, the first, second, and third phase bars 462a, 462b, 462c are substantially concentric about the buss bar central axis 456. In the depicted embodiment, the phase bars 462 are round wire material each formed into a substantially annular shape. The phase bars 462a, 462b, and 462c are cooperatively configured such that they each alternatingly provide a respective, circumferentially extending portion 463a, 463b, or 463c that substantially lies in an imaginary plane 464 (FIG. 34) that is perpendicular to the buss bar central axis 456.

Substantially annular buss bar housing 454 includes a radially inner exterior surface 466 and a radially outer exterior surface 468. On the radially outer surface 468 are eighteen locations 470 at which are phase bar electrical contacts 472 electrically engageable from outside of the buss bar body 452 or housing 454. Locations 470 are, as in the first and second embodiment buss bar assemblies 70, 70-1, distributed at 20° intervals about the buss bar central axis 456. Contacts 472 are defined by the circumferentially-extending portions 463 of the phase bars 462 that are located in imaginary plane 464. Thus, each of the phase bars 462a, 462b, and 462c is associated with a plurality of contacts 472a, 472b, and 472c, respectively. At each of locations 470 a phase bar electrical connection terminal 474 is in electrical communication with the phase bar electrical contact 472. First, second, and third phase bar electrical terminals 474a, 474b, 474c are connected to phase bar electrical contacts 472a, 472b, 472c at locations 470a, 470b, 470c, respectively. In the depicted embodiment, contacts 472 and terminals 474 are integral with their respective phase bar 462, and formed by the circumferentially extending phase bar portions 463. The phase bars 462 are thus electrically engageable through their respective contacts 472 and terminals 474 from outside of the body 452 or housing 454 of the buss bar assembly 450.

The phase bars 462a, 462b, and 462c are interwoven within the housing 454, such that they alternatingly present a respective contact 472a, 472b, or 472c every 20° about the buss bar central axis 456 at a location 470, with each contact 472 being located in the common imaginary plane 464, thereby minimizing the overall axial height of the buss bar assembly 450. It can thus be understood that the radius R (FIG. 33) of a respective phase bar 462a, 462b, or 462c has varying distances from the buss bar central axis 456, and ranges from a maximum value Rₚ₋ₘₐₓ when defining a contact 472a, 472b, or 472c, and a minimum value Rₚ₋ₘᵢₙ within the overmolded buss bar body 452, as shown in FIGS. 33 and 35. It can thus be further understood that the axial positions relative to axis 456 of the phase bars 462 at different circumferential locations therealong will vary. Referring to FIG. 34, these positions will vary between one axial limit at imaginary plane 464x in which contacts 472 are located, and a second axial limit at parallel imaginary plane 464y in which phase power terminals 476 are located. In the depicted embodiment, plane 464x is nearest body inner face 458, and plane 464y is nearest axially opposed body outer face 460.

As best shown in FIG. 32, the phase power terminals 476 are provided by which electrical power to or from the coil winding assemblies is transferred to or from the buss bar assembly 450, as the case may be. The first, second, and third phase power terminals 476a, 476b, and 476c, respectively, may, for example, be angularly spaced from each other by either 20° or 40° about the buss bar central axis 456, and defined by opposite ends of the round wire material between which the substantially annular phase bar 462 is formed. As shown, phase power terminals 476 extend radially from radially outer exterior surface 468 of the housing 454 along plane 464y. Alternatively, the locations at which the phase power terminals 476 extend from the body 452 may be radially aligned relative to the central axis 456 and spaced axially therealong, preferably at a location circumferentially centered between a pair of adjacent contacts, in a manner similar to that shown in FIG. 5C.

Buss bar assembly 450 may optionally include a substantially annular, round wire neutral bar (not shown) partially disposed within the overmolded body 452. The neutral bar, if included, and its supporting body portion may have a configuration similar to that of neutral bar 228 and body 202 of the fourth embodiment buss bar assembly 200. The neutral bar, if included, may be substantially concentric about the buss bar central axis 456 and located at a distance therefrom smaller than radius Rₚ₋ₘᵢₙ, and preferably in an imaginary plane (not shown) located between planes 464x and 464y, or co-located with either. It is to be understood that the inclusion of a neutral bar and its associated electrical contacts and connection terminals is optional, and may be included in certain variants (not shown) of the ninth embodiment buss bar assembly 450. In such alternative configurations, the second, neutral leads of a cooperating arranged plurality of coil winding assemblies (not shown) may have neutral lead terminals that extend axially relative to the stator central axis in a manner similar to the neutral lead terminals 58 shown in FIG. 3B, and which would be interconnected internally of the buss bar assembly 450.

While exemplary embodiments have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A buss bar assembly for electrically interconnecting phase leads of respective pluralities of first, second, and third phase coil winding assemblies arranged about a stator central axis, said buss bar assembly comprising:
a substantially annular dielectric body defining a buss bar central axis, said body having, relative to said buss bar central axis, axially opposed inner and outer faces and radially inner and outer exterior surfaces; and
substantially annular first, second, and third electrically conductive phase bars disposed about said buss bar central axis and electrically isolated from each other, each of said first, second, and third phase bars at least partially disposed within said body and having a first, second, and third plurality, respectively, of electrical phase bar contacts angularly spaced from each other at locations about said buss bar central axis, said phase bar contacts electrically engagable from outside of said body;
said buss bar assembly being adapted for installation relative to a plurality of coil winding assemblies arranged about a stator central axis such that the stator central axis is substantially surrounded by said body, the arranged plurality of coil winding assemblies is interfaced by said body inner face, and phase leads of the first, second, and third phase coil winding assemblies are electrically engaged with said first, second, and third pluralities of phase bar contacts, respectively.

2. The buss bar assembly of claim 1, wherein portions of said first, second, and third phase bars located inside of said body are substantially aligned in a direction parallel with said buss bar central axis.

3. The buss bar assembly of claim 2, wherein portions of said first, second, and third phase bars located inside of said body substantially lie in first, second, and third substantially parallel imaginary planes, respectively, said imaginary planes substantially perpendicular to said buss bar central axis, at least two of said imaginary planes optionally spaced from each other along said buss bar central axis.

4. The buss bar assembly of claim 1, wherein portions of said first, second, and third phase bars located inside of said body are substantially aligned in a radial direction relative to said buss bar central axis.

5. The buss bar assembly of claim 4, wherein said portions of said first, second, and third phase bars located inside of said body and substantially aligned in a radial direction relative to said buss bar central axis are substantially concentric relative to said buss bar central axis.

6. The buss bar assembly of claim 1, wherein said body is over-molded relative to said first, second, and third phase bars.

7. The buss bar assembly of claim 1, wherein said phase bar contact locations superpose a said exterior surface.

8. The buss bar assembly of claim 7, wherein said phase bar contact locations superpose one of said radially inner and outer exterior surfaces of said body.

9. The buss bar assembly of claim 1, wherein said phase bar contact locations superpose said outer face of said body.

10. The buss bar assembly of claim 1, wherein portions of said phase bar contacts substantially lie in a common imaginary plane substantially perpendicular to said buss bar central axis.

11. The buss bar assembly of claim 1, wherein each said plurality of phase bar contacts is electrically connected to its respective first, second, or third phase bar inside of said body.

12. The buss bar assembly of claim 7, wherein each said phase bar has circumferentially alternating radially inner and radially outer phase bar segments located at radially spaced distances from said buss bar central axis, said radially inner phase bar segments are disposed within said body, and said radially outer phase bar segments are disposed outside of said body.

13. The buss bar assembly of claim 1, wherein each said phase bar has a phase power transmission terminal projecting from said body for power transmission through said buss bar assembly to or from the phase leads of the respective plurality of first, second, or third phase coil winding assemblies of an arranged plurality of coil winding assemblies to which said buss bar assembly is adapted for installation.

14. The buss bar assembly of claim 1, said buss bar assembly for also electrically connecting neutral leads extending from the pluralities of first, second, and third phase coil winding assemblies and further comprising:
a substantially annular electrically conductive neutral bar disposed about said buss bar central axis, said neutral bar at least partially disposed within said body and electrically isolated from said phase bars within said body, said neutral bar having a plurality of electrical neutral bar contacts angularly spaced from each other at locations about said buss bar central axis, said neutral bar contacts electrically engagable from outside of said body;
wherein said buss bar assembly is further adapted for installation relative to the plurality of first, second, and third phase coil winding assemblies such that neutral leads of the first, second, and third phase coil winding assemblies are electrically engaged with said plurality of neutral bar contacts.

15. The buss bar assembly of claim 14, wherein said neutral bar contact locations superpose said radially inner exterior surface.

16. A buss bar assembly for electrically interconnecting phase leads of respective pluralities of first, second, and third phase coil winding assemblies arranged about a stator central axis, said buss bar assembly comprising:
a substantially annular dielectric body defining a buss bar central axis, said body having, relative to said buss bar central axis, axially opposed inner and outer faces and radially inner and radially outer exterior surfaces; and
substantially annular electrically conductive first, second, and third phase bars disposed about said buss bar central axis and electrically isolated from each other, each said phase bar at least partially disposed within said body and having a respective plurality of electrical phase bar contacts at fixed locations relative to said body, each said phase bar contact electrically engageable from outside of said body and angularly spaced from another of said plurality of phase bar contacts about said buss bar central axis;
said buss bar assembly being adapted for installation to an arranged plurality of first, second, and third coil winding assemblies in a mutually registered position in which:
said buss bar body substantially surrounds the stator central axis,
said body inner face interfaces the arranged plurality of coil winding assemblies, and
said first, second, and third pluralities of phase bar contacts are respectively electrically engaged with the respective phase leads of the first, second, and third coil winding assemblies.

17. The buss bar assembly of claim 16, wherein each of said first, second, and third pluralities of phase bar contacts are angularly spaced from another of the respective said first, second, or third plurality of phase bar contacts about said buss bar central axis, and said phase bar contacts superpose one of a said body face and a said body exterior surface.

18. The buss bar assembly of claim 17, wherein said phase bar contacts of each respective said first, second, and third plurality of phase bar contacts are angularly spaced from each other about said buss bar central axis.

19. The buss bar assembly of claim 16, wherein said body comprises a molded first portion defining a recess in which said first, second, and third phase bars are disposed, and further comprising a second portion superposing said phase bars and connected to said first portion.

20. The buss bar assembly of claim 19, wherein said second portion comprises a liquid resin that has been received into said first portion recess and cured.
